(19) United States
(12) Patent Application Publication
(10) Pub. No.: US 2025/0038219 A1
(43) Pub. Date: Jan. 30, 2025

(54) PROCESSES FOR FORMING CARBON-SUPPORTED HOLLOW NANOCATALYSTS

(71) Applicant: Honda Motor Co., Ltd., Tokyo (JP)

(72) Inventors: Shutang CHEN, Livermore, CA (US); Yiman ZHANG, San Jose, CA (US)

(21) Appl. No.: 18/226,704

(22) Filed: Jul. 26, 2023

(51) Int. Cl. H01M 4/92; H01M 4/88

(52) U.S. Cl. CPC H01M 4/926; H01M 4/88

(57) ABSTRACT

Aspects of the present disclosure generally relate to processes for forming carbon-supported hollow nanocatalysts. In an aspect, a process for forming a carbon-supported nanoframe is provided. The process includes forming a bimetallic structure by reacting a first precursor comprising platinum (Pt) and a second precursor comprising a Group 8-11 metal at a temperature of about 80° C. to about 300° C., wherein the Group 8-11 metal is free of Pt. The process further includes forming a carbon-supported bimetallic nanoframe by reacting a mixture comprising the bimetallic structure, a carbon source, and an acid, wherein: the carbon-supported bimetallic nanoframe comprises a bimetallic nanoframe chemically bonded to a carbon support, and the bimetallic nanoframe has a higher molar ratio of Pt to Group 8-11 metal than a molar ratio of Pt to Group 8-11 metal of the bimetallic structure.

### FIELD

Aspects of the present disclosure generally relate to processes for forming carbon-supported hollow nanocatalysts.

### BACKGROUND

Various metal catalysts, are utilized in fuel cells to enhance the conversion of raw materials to energy via direct electrochemical oxygen reduction reactions and hydrogen evolution reactions. Platinum is the most commonly used and effective catalyst for fuel cells, and specifically, for proton exchange membrane fuel cells (PEMFCs). However, the high cost, durability, and efficiency of conventional platinum catalysts limit its widespread adoption in fuel cells, PEMFCs, and other areas where large amounts of platinum are needed. Although conventional Pt-based hollow nanocatalysts have demonstrated excellent catalytic performance, these conventional catalysts easily dissolve into solution (such as acid solutions) or the metal drops off from the carbon support. That is, conventional technologies lack stable bonds between the metal and the carbon support, and the art lacks a consistent method to stabilize hollow catalysts on carbon supports through chemical bonding.

There is a need for new and improved processes for forming carbon-supported hollow nanocatalysts.

### SUMMARY

Aspects of the present disclosure generally relate to processes for forming carbon-supported hollow nanocatalysts. Unlike conventional carbon-supported Pt-based hollow nanocatalysts which easily dissolve into an electrolyte solution or drop off from carbon supports, carbon-supported Pt-based hollow nanocatalysts formed by aspects described herein are stable due to, for example, chemical bonding between the nanocatalysts and the carbon support. The catalytic performance of the supported catalysts formed by aspects described herein far exceed those catalysts commercially available such as Pt/C.

In an aspect, a process for forming a carbon-supported nanoframe is provided. The process includes forming a bimetallic structure by reacting a first precursor comprising platinum (Pt) and a second precursor comprising a Group 8-11 metal at a temperature of about 80° C. to about 300° C., wherein the Group 8-11 metal is free of Pt. The process further includes forming a carbon-supported bimetallic nanoframe by reacting a mixture comprising the bimetallic structure, a carbon source, and an acid, wherein: the carbon-supported bimetallic nanoframe comprises a bimetallic nanoframe chemically bonded to a carbon support, and the bimetallic nanoframe has a higher molar ratio of Pt to Group 8-11 metal than a molar ratio of Pt to Group 8-11 metal of the bimetallic structure.

In another aspect, a process for forming a carbon-supported nanoframe is provided. The process includes introducing a first metal precursor comprising a Group 8-11 metal with a mixture comprising a phosphorous-containing compound and a second metal precursor comprising a Group 10-11 metal to form a bimetallic structure, the Group 8-11 metal and the Group 10-11 metal being different, the Group 8-11 metal and the Group 10-11 metal being free of platinum. The process further includes introducing a platinum-containing precursor with the bimetallic structure to form a trimetallic structure. The process further includes forming a carbon-supported trimetallic nanoframe by reacting a mixture comprising the trimetallic structure, a carbon source, and an acid, wherein: the carbon-supported trimetallic nanoframe comprises a trimetallic nanoframe chemically bonded to a carbon support, and the trimetallic nanoframe has a higher molar ratio of Pt to total amount of Group 8-11 and Group 10-11 metal than a molar ratio of Pt to a total amount of Group 8-11 and Group 10-11 metal of the trimetallic structure.

In another aspect, a process for converting a solid catalyst to a conversion product is provided. The process includes exposing a solid metal catalyst and a carbon source to an acid to form an at least partially hollow metal catalyst chemically bonded to a carbon support, wherein: each of the solid metal catalyst and the at least partially hollow metal catalyst comprises Pt and at least one Group 8-11 metal of the periodic table of the elements, the at least one Group 8-11 metal is free of Pt, and a molar ratio of Pt to the at least one Group 8-11 metal of the at least partially hollow metal catalyst is higher than a molar ratio Pt to the at least one Group 8-11 metal of the solid metal catalyst.

### BRIEF DESCRIPTION OF THE DRAWINGS

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only exemplary aspects and are therefore not to be considered limiting of its scope, for the disclosure may admit to other equally effective aspects.

FIG. 1A is a non-limiting illustration of a nanocrystal according to at least one aspect of the present disclosure.

FIG. 1B is a non-limiting illustration of a hollow nanocrystal according to at least one aspect of the present disclosure.

FIG. 2A is an example reaction diagram for forming a carbon-supported bimetallic nanoframe according to at least one aspect of the present disclosure.

FIG. 2B is an example reaction diagram for forming a Group 10-11 metal complex according to at least one aspect of the present disclosure.

FIG. 2C is an example reaction diagram for forming a Group 8-11 metal complex according to at least one aspect of the present disclosure.

FIG. 3 is a flowchart showing selected operations of an example process for forming a carbon-supported bimetallic nanoframe according to at least one aspect of the present disclosure.

FIG. 4A is an example reaction diagram for forming a carbon-supported trimetallic nanoframe according to at least one aspect of the present disclosure.

FIG. 4B is an example reaction diagram for forming a platinum-containing metal complex according to at least one aspect of the present disclosure.

FIG. 5 is a flowchart showing selected operations of an example process for forming a carbon-supported trimetallic nanoframe according to at least one aspect of the present disclosure.

FIG. 6A shows a general reaction scheme for converting Pt-based solid nanocatalysts to Pt-based hollow nanocatalysts on carbon supports according to at least one aspect of the present disclosure.

FIG. 6B shows a transmission electron microscope (TEM) image of example Pt—Ni dodecahedron nanoparticles according to at least one aspect of the present disclosure.

FIG. 6C shows a TEM image of example Pt—Ni nanoframes on carbon supports according to at least one aspect of the present disclosure.

FIG. 7A shows a scanning electron microscope (SEM) image of example Pt—Ni nanoframes on carbon supports (2:3 weight ratio of catalyst to carbon source) formed by acetic acid treatment according to at least one aspect of the present disclosure. (scale: 50 μm).

FIG. 7B shows a SEM image of example Pt—Ni nanoframes on carbon supports (2:3 weight ratio of catalyst to carbon source) formed by acetic acid treatment according to at least one aspect of the present disclosure. (scale: 500 nm).

FIG. 7C shows a TEM image of example Pt—Ni nanoframes on carbon supports (2:3 weight ratio of catalyst to carbon source) formed by acetic acid treatment according to at least one aspect of the present disclosure. (scale: 0.5 μm).

FIG. 7D shows a TEM image of example Pt—Ni nanoframes on carbon supports (2:3 weight ratio of catalyst to carbon source) formed by acetic acid treatment according to at least one aspect of the present disclosure. (scale: 200 nm).

FIGS. 8A and 8B show SEM (scale: 1 μm) and TEM (scale: 200 nm) images, respectively, of example Pt—Ni nanoframes on carbon supports (1:1 weight ratio of catalyst to carbon source) formed by acetic acid treatment according to at least one aspect of the present disclosure.

FIGS. 8C and 8D show SEM (scale: 500 nm) and TEM (scale: 100 nm) images, respectively, of example Pt—Ni nanoframes on carbon supports (2:1 weight ratio of catalyst to carbon source) formed by acetic acid treatment according to at least one aspect of the present disclosure.

FIGS. 8E and 8F show SEM (scale: 500 nm) and TEM (scale: 100 nm) images, respectively, of example Pt—Ni nanoframes on carbon supports (1:1 weight ratio of catalyst to carbon source) formed by sulfuric acid treatment according to at least one aspect of the present disclosure.

FIG. 9 shows an overlay of x-ray diffraction (XRD) patterns of example Pt—Ni nanoframes on carbon supports at different weight ratios and formed with different acids according to at least one aspect of the present disclosure.

FIGS. 10A and 10B show TEM images (scale: 1 μm and 50 nm, respectively), of example Pt—Ni—Cu nanoframes on carbon supports (2:3 weight ratio of catalyst to carbon source) formed by sulfuric acid treatment according to at least one aspect of the present disclosure.

FIG. 11 shows an overlay of XRD patterns of Pt—Ni—Cu nanoframes on carbon supports according to at least one aspect of the present disclosure.

FIG. 12A shows a TEM image of example Pt—Ni—Cu nanoframes on carbon supports (2:1 weight ratio of catalyst to carbon source) formed by sulfuric acid treatment according to at least one aspect of the present disclosure. (scale: 1 μm)

FIGS. 12B and 12C show SEM images (scale: 1 μm and 2 μm, respectively), of example Pt—Ni—Cu nanoframes on carbon supports (2:1 weight ratio of catalyst to carbon source) formed by sulfuric acid treatment according to at least one aspect of the present disclosure.

FIG. 13A shows cyclic voltammetry curves of an example Pt—Ni/C hollow nanocatalyst and a comparative Pt/C catalyst according to at least one aspect of the present disclosure.

FIG. 13B shows linear sweeping voltammetry curves of an example Pt—Ni/C hollow nanocatalyst and a comparative Pt/C catalyst according to at least one aspect of the present disclosure.

### DETAILED DESCRIPTION

Aspects of the present disclosure generally relate to processes for forming carbon-supported hollow nanocatalysts. The inventors have found processes that can, for example, form stable carbon-supported Pt-based hollow nanocatalysts. Unlike conventional carbon-supported Pt-based hollow nanocatalysts which easily dissolve into an electrolyte solution or drop off from carbon supports, carbon-supported Pt-based hollow nanocatalysts formed by aspects described herein are stable due to, for example, chemical bonding between the nanocatalysts and the carbon support. In some examples, the chemical bonding between the nanocatalysts and the carbon support can be through carboxyl groups (—COOH) and/or ions thereof (—COO⁻) present on the carbon support that bond to one or more metals of nanocatalysts

Briefly, and in some aspects, processes described herein can include formation of a nanocatalyst (for example, a bimetallic structure or a trimetallic structure), and introducing the nanocatalyst with a carbon source and an acid to form a carbon-supported nanoframe. The nanoframe is a catalyst and can be, or include, a bimetallic structure or a trimetallic structure. The acid treatment can convert the solid nanocatalyst to a nanoframe (an at least partially hollow nanocatalyst). The acid treatment can also enable chemical bonding between one or more metals of the nanoframe and surface carboxyl groups (and/or ions thereof) of the carbon support. In contrast, conventional technologies utilize physical loading of catalysts on supports, resulting in unstable carbon-supported catalysts.

As further described below, the catalytic performance of the supported catalysts formed by aspects described herein far exceed those catalysts commercially available such as Pt/C. For example, and in some aspects, supported catalysts described herein can have mass activities that are about 23 times higher (or more) than commercial Pt/C electrocatalysts and about 50% higher (or more) than the Department of Energy (DOE) target for electrocatalysts (DOE target: mass activity >0.44 A/mg (Pt) in PEMFCs).

Aspects described herein can enable control over the morphology of the nanoframe structure, its chemical properties, and the number of active surface sites, among other chemical and physical characteristics. The nanoframe can be utilized as a catalyst in, for example, electrochemical oxygen reduction reactions (ORR) and hydrogen evolution reactions, among other reactions. In such applications, the nanoframe can be integrated into a portion of, for example, a reactor, a fuel cell device such as a PEMFC device, or other devices useful for performing conversion reactions, among other applications. The enhanced performance and durability of carbon-supported catalysts formed by aspects described herein can meet the needs of heavy-duty fuel cell technology.

The use of headings is for purposes of convenience only and does not limit the scope of the present disclosure. Aspects described herein can be combined with other aspects.

As used herein, a “composition” can include component(s) of the composition, reaction product(s) of two or more components of the composition, and/or a remainder balance of remaining starting component(s). Compositions of the present disclosure can be prepared by any suitable mixing process.

As used herein, a “bimetallic structure” can include component(s) of the bimetallic structure, reaction product(s) of two or more components of the bimetallic structure, and/or a remainder balance of remaining starting component(s). As used herein, a “carbon-supported bimetallic nanoframe” can include component(s) of the carbon-supported bimetallic nanoframe, reaction product(s) of two or more components of the carbon-supported bimetallic nanoframe, and/or a remainder balance of remaining starting component(s).

As used herein, a “trimetallic structure” can include component(s) of the trimetallic structure, reaction product(s) of two or more components of the trimetallic structure, and/or a remainder balance of remaining starting component(s). As used herein, a “carbon-supported trimetallic nanoframe” can include component(s) of the carbon-supported trimetallic nanoframe, reaction product(s) of two or more components of the carbon-supported trimetallic nanoframe, and/or a remainder balance of remaining starting component(s).

Aspects of the present disclosure generally relate to processes for forming carbon-supported bimetallic catalyst nanoparticles and carbon-supported trimetallic catalyst nanoparticles. Carbon-supported catalyst nanoparticles can include metallic structures (such as bimetallic structures, trimetallic structures, or combinations thereof) chemically bonded to a surface of a carbon support. The chemical bonding between the nanocatalysts and the carbon support can be through carboxyl groups (—COOH) and/or ions thereof (—COO⁻) present on the carbon support and one or more metals of the metallic structures.

### Metallic Structures

Metallic structures formed by aspects described herein can be in the form of, nanostructures nanoparticles, nanocrystals, nanocages, and/or nanoframes, though other structures as well as other sizes (for example, macro and micro) are contemplated. The nanostructure can be in the form of a complex, alloy, compound, coordination compound, or the like, or combinations thereof. The nanostructures can be in the form of a composition or form at least a portion of a composition, for example, a catalyst composition. As further described below, the nanostructures formed by aspects described herein can be useful for conversion reactions such as electrocatalytic conversion reactions. Illustrative, but non-limiting, examples of the electrocatalytic conversion reaction include oxygen reduction reaction (ORR), oxygen evolution reaction (OER), hydrogen evolution reaction (HER) such as the conversion of water into hydrogen, and the oxidation of alcohols.

Metallic described herein can include two or more metals. Bimetallic structures include two metals and trimetallic structures include three metals. The first metal is a Group 10-11 metal of the periodic table of the elements such as nickel (Ni), palladium (Pd), platinum (Pt), copper (Cu), silver (Ag), gold (Au), or combinations thereof, such as Ni, Cu, or combinations thereof. The second metal is a Group 8-11 metal of the periodic table of elements, such as iron (Fe), ruthenium (Ru), osmium (Os), cobalt (Co), rhodium (Rh), iridium (Ir), Ni, Pd, Pt, Cu, Ag, Au, or combinations thereof, such as Fe, Co, Ni, Pd, Pt, Cu, Ag, Au, or combinations thereof. The first metal (the Group 10-11 metal) is different from the second metal (the Group 8-11 metal).

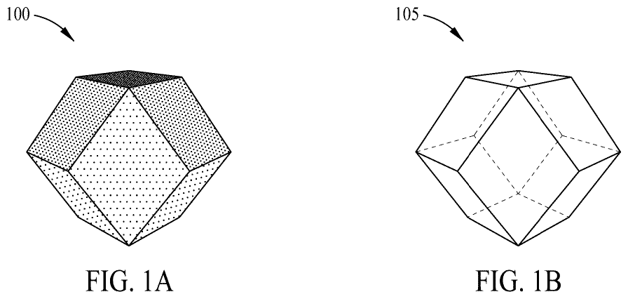

FIG. 1A shows an illustration of a dodecahedral nanocrystal 100 and FIG. 1B is an exemplary, non-limiting, illustration of a metallic structure in the form of a hollow dodecahedral nanocrystal 105 (or nanoframe). Such hollow, substantially hollow, or partially hollow nanocrystals are used in catalyst compositions described herein. It is contemplated that the metallic structure have other three-dimensional shapes (e.g., polyhedra, such as rhombic, cubic, cuboctahedral, etc.) with any suitable number of faces.

A nanoframe is a nanostructured material that includes a plurality of interconnected struts arranged to form the edges of a polyhedron, defining a partially hollow, substantially hollow, or hollow interior volume. An overall surface area to volume ratio (surface-to-volume ratio) of the nanoframe is greater than that of an identically shaped polyhedral particle having solid interior volume. Nanoframes are unique for their three-dimensional, highly open architecture. Nanoframes can be characterized as having disordered, defective, or otherwise irregular morphologies. The nanoframes of carbon-supported catalysts described herein can be attractive for use as heterogeneous catalysts because of, e.g., their high density of catalytically-active sites and large specific surface areas. The high number of catalytically-active sites and large specific surface areas of the hollow nanocrystals relative to solid nanocrystals, is due to, e.g., the aforementioned defects. Due to such properties, lower catalyst loads with lower costs can be achieved in various conversion reactions.

The metallic structures used in the catalyst compositions can be in the form of homogeneous structures such as an alloy structure, as well as heterogeneous structures such as a core-shell structure, a core-shell-frame structure, and/or a heterostructure. Other metallic structures include intermetallic structures and partial alloys. Each of these different types of metallic structures can have different physical performance capabilities.

The metallic structure has a suitable concentration of “defects”. A “defect” refers to vacancies, stacking faults, grain boundary, edge dislocation, or other defects of the metallic structures described herein. The defect(s) can promote catalytic activity of the catalyst composition by, e.g., increasing the active sites and surface area to which protons can bond. The surface defects can be observed by HRTEM.

As discussed above, the metallic structure can be in the form of, e.g., a bimetallic structure. The bimetallic structure includes two metals. The first metal is a Group 8-11 metal of the periodic table of elements, such as iron (Fe), ruthenium (Ru), osmium (Os), cobalt (Co), rhodium (Rh), iridium (Ir), Ni, Pd, Pt, Cu, Ag, Au, or combinations thereof, such as Fe, Co, Ni, Pd, Pt, Cu, Ag, Au, or combinations thereof. The second metal is a Group 10-11 metal of the periodic table of the elements, such as nickel (Ni), copper (Cu), palladium (Pd), platinum (Pt), silver (Ag), gold (Au), or combinations thereof, such as Ni, Cu, or a combination thereof. The Group 10-11 metal is different from the Group 8-11 metal.

The bimetallic structure can also include one or more elements from Group 13-16 of the periodic table of the elements such as phosphorous, nitrogen, or a combination thereof. The one or more elements from Group 13-16, e.g., phosphorous atoms, nitrogen atoms, sulfur atoms, and/or oxygen atoms, can be in the form of ligand(s) and/or chelating group(s) bound to the Group 10-11 metal, the Group 8-11 metal, or combinations thereof. The ligand(s) and/or chelating group(s), when present, can be in the form of neutral species, monodentate species, bidentate species, and/or polydentate species.

In some aspects, the bimetallic structure has the formula (I):

(M¹)ₐ(M²)_{b} (I),
wherein:
M¹ is a Group 8-11 metal of the periodic table of the elements, such as Fe, Ru, Os, Co, Rh, Ir, Ni, Pd, Pt, Cu, Ag, or Au, such as Fe, Co, Ni, Pd, Pt, Cu, Ag, or Au, such as Pt, Ni, or Cu;
M² is a Group 10-11 metal of the periodic table of the elements, such as Ni, Cu, Pd, Ag, or Au, such as Ni or Cu, or a combination thereof;
M¹ and M² being different metals;
a is the amount of M¹; and
b is the amount of M²; and

A molar ratio of a:b can be from about 1:99 to about 99:1, such as from about 10:90 to about 90:10, such as from about 20:80 to about 80:20, such as from about 30:70 to about 70:30, such as from about 40:60 to about 60:40, such as from about 45:55 to about 55:45, such as from about 48:52 to about 50:50. In some aspects, a molar ratio of a:b can be from about 20:1 to about 1:20, such as from about 10:1 to about 1:10, such as from about 5:1 to about 1:5, such as from about 3:1 to about 1:3, such as from about 2:1 to about 1:2. In at least one aspect, a molar ratio of a:b is from about 1:99 to about 20:1, such as from about 5:95 to about 10:1, such as from about 10:90 to about 1:1, such as from about 30:70 to about 40:60.

For the bimetallic structure of formula (I), the molar ratio of a:b is determined by inductively coupled plasma-mass spectrometry (ICP-MS) of the bimetallic structure being analyzed.

For processes for producing a bimetallic structure of formula (I), the molar ratio of a:b of the bimetallic structure is determined based on the starting material molar ratio used for the synthesis.

The trimetallic structure includes three metals. The first metal is Pt; the second metal is a Group 10-11 metal that is different from Pt, such as Ni, Cu, Pd, Ag, Au, or combinations thereof, such as Ni, Cu, or combinations thereof; and the third metal is a Group 8-11 metal that is different from Pt and different from the Group 10-11 metal. In some aspects, the third metal (the Group 8-11 metal) comprises Fe, Ru, Os, Co, Rh, Ir, Ni, Pd, Cu, Ag, Au, or combinations thereof, such as Fe, Co, Ni, Pd, Cu, Ag, Au, or combinations thereof. Each of the three metals of the trimetallic structure are different.

The trimetallic structures can also include one or more elements from Group 13-16 of the periodic table of the elements such as phosphorous, nitrogen, or a combination thereof. The one or more elements from Group 13-16, e.g., phosphorous atoms, nitrogen atoms, sulfur atoms and/or oxygen atoms, can be in the form of ligand(s) and/or chelating group(s) bound to the Pt metal, the Group 10-11 metal, the Group 8-11 metal, or combinations thereof. The ligand(s) and/or chelating group(s), when present, can be in the form of neutral species, monodentate species, bidentate species, and/or polydentate species.

In some aspects, the trimetallic structure has the formula (II) or a combination thereof:

(M³)_{c}(M⁴)_{d}(M⁵)ₑ (II),
wherein:
M³ is Pt;
M⁴ is a Group 10-11 metal of the periodic table of the elements, such as Ni, Cu, Pd, Ag, or Au, such as Ni or Cu;
M⁵ is a Group 8-11 metal of the periodic table of the elements, such as Fe, Ru, Os, Co, Rh, Ir, Ni, Pd, Cu, Ag, or Au, such as Fe, Co, Ni, Pd, Cu, Ag, or Au;
M³, M⁴, and M⁵ being different metals;
c is the amount of M³;
d is the amount of M⁴; and
e is the amount of M⁵;

A molar ratio of c:d can be from about 1:98 to about 98:1, such as from about 9:90 to about 90:9, such as from about 20:79 to about 79:20, such as from about 30:69 to about 69:30, such as from about 40:59 to about 59:40, such as from about 45:54 to about 54:45, such as from about 47:52 to about 50:49. In some aspects, a molar ratio of c:d can be from about 20:1 to about 1:20, such as from about 10:1 to about 1:10, such as from about 5:1 to about 1:5, such as from about 3:1 to about 1:3, such as from about 2:1 to about 1:2. In at least one aspect, a molar ratio of c:d is from about 1:98 to about 20:1, such as from about 4:95 to about 10:1, such as from about 9:90 to about 1:1, such as from about 29:70 to about 40:59.

A molar ratio of c:e can be from about 1:98 to about 98:1, such as from about 9:90 to about 90:9, such as from about 20:79 to about 79:20, such as from about 30:69 to about 69:30, such as from about 40:59 to about 59:40, such as from about 45:54 to about 54:45, such as from about 47:52 to about 50:49. In some aspects, a molar ratio of c:e can be from about 20:1 to about 1:20, such as from about 10:1 to about 1:10, such as from about 5:1 to about 1:5, such as from about 3:1 to about 1:3, such as from about 2:1 to about 1:2. In at least one aspect, a molar ratio of c:e is from about 1:98 to about 20:1, such as from about 4:95 to about 10:1, such as from about 9:90 to about 1:1, such as from about 29:70 to about 40:59.

A molar ratio of d:e can be from about 1:98 to about 98:1, such as from about 9:90 to about 90:9, such as from about 20:79 to about 79:20, such as from about 30:69 to about 69:30, such as from about 40:59 to about 59:40, such as from about 45:54 to about 54:45, such as from about 47:52 to about 50:49. In some aspects, a molar ratio of d:e can be from about 20:1 to about 1:20, such as from about 10:1 to about 1:10, such as from about 5:1 to about 1:5, such as from about 3:1 to about 1:3, such as from about 2:1 to about 1:2. In at least one aspect, a molar ratio of die is from about 1:98 to about 20:1, such as from about 4:95 to about 10:1, such as from about 9:90 to about 2:1, such as from about 29:70 to about 40:59.

A molar ratio of c:(d+e) can be from about 1:99 to about 99:1, such as from about 10:90 to about 90:10, such as from about 20:80 to about 80:20, such as from about 30:70 to about 70:30, such as from about 40:60 to about 60:40. In at least one aspect, a molar ratio c:(d+e) is from about 50:1 to about 1:50, such as from about 40:1 to about 1:40, such as from about 30:1 to about 1:30, such as from about 20:1 to about 1:20, such as from about 10:1 to about 1:10.

For the trimetallic structure of formula (II), the molar ratios of c:d, d:e, c:e, and c:(d+e) are determined by ICP-MS of the trimetallic structure being analyzed.

For processes for the trimetallic structure of formula (II), the molar ratios of c:d, c:e, d:e, and c:(d+e) of the trimetallic structure are determined based on the starting material molar ratio used for the synthesis.

When the metallic structure includes a phosphorous group, the phosphorous group originates from a phosphorous-containing compound utilized for the synthesis of the metallic structure. Such phosphorous-containing compounds include phosphines having the formula

PR¹R²R³,
wherein:
each of R¹, R², and R³ is independently selected from hydrogen, unsubstituted hydrocarbyl, substituted hydrocarbyl, unsubstituted aryl, substituted aryl, or two or more of R¹, R² and/or R³ may join together to form a substituted or unsubstituted, cyclic or polycyclic ring structure. Unsubstituted hydrocarbyl includes C₁-C₁₀₀ unsubstituted hydrocarbyl, such as C₁-C₄₀ unsubstituted hydrocarbyl, such as C₁-C₂₀ unsubstituted hydrocarbyl, such as C₁-C₁₀ unsubstituted hydrocarbyl, such as C₁-C₆ unsubstituted hydrocarbyl. Substituted hydrocarbyl includes C₁-C₁₀₀ substituted hydrocarbyl, such as C₁-C₄₀ substituted hydrocarbyl, such as C₁-C₂₀ substituted hydrocarbyl, such as C₁-C₁₀ substituted hydrocarbyl, such as C₁-C₆ substituted hydrocarbyl. Unsubstituted aryl includes C₄-C₁₀₀ unsubstituted aryl, such as C₄-C₄₀ unsubstituted aryl, such as C₄-C₂₀ unsubstituted aryl, such as C₄-C₁₀ unsubstituted aryl. Substituted aryl includes C₄-C₁₀₀ substituted aryl, such as a C₄-C₄₀ substituted aryl, such as C₄-C₂₀ substituted aryl, such as C₄-C₁₀.

Each of R¹, R², and R³ is, independently, saturated or unsaturated, linear or branched, cyclic or acyclic, aromatic or non-aromatic. When one or more of R¹, R², and/or R³ is joined together, the formed structure may be substituted or unsubstituted, fully saturated, partially unsaturated, or fully unsaturated, aromatic or non-aromatic, cyclic or polycyclic.

For the purposes of this present disclosure, and unless otherwise specified, the terms “hydrocarbyl radical,” “hydrocarbyl group,” or “hydrocarbyl” interchangeably refer to a group consisting of hydrogen and carbon atoms only. A hydrocarbyl group can be saturated or unsaturated, linear or branched, cyclic or acyclic, aromatic, or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, and aryl groups, such as phenyl, benzyl, naphthyl.

For the purposes of this present disclosure, and unless otherwise specified, the term “aryl” or “aryl group” interchangeably refers to a hydrocarbyl group comprising an aromatic ring structure therein.

“Hydrocarbyl”, “aryl”, “substituted hydrocarbyl”, and “substituted aryl” are described above. “Substituted alkenyl” refers to an alkenyl, where at least one hydrogen of the alkenyl has been substituted with at least one heteroatom or heteroatom-containing group, such as one or more elements from Group 13-17 of the periodic table of the elements, such as halogen (F, Cl, Br, or I), O, N, Se, Te, P, As, Sb, S, B, Si, Ge, Sn, Pb, and the like, such as C(O)R*, C(C)NR*₂, C(O)OR*, NR*₂, OR*, SeR*, TeR*, PR*₂, AsR*₂, SbR*₂, SR*, SOₓ (where x=2 or 3), BR*₂, SiR*₃, GeR*₃, SnR*₃, PbR*₃, and the like or where at least one heteroatom has been inserted within the alkenyl radical such as one or more of halogen (Cl, Br, I, F), O, N, S, Se, Te, NR*, PR*, AsR*, SbR*, BR*, SiR*₂, GeR*₂, SnR*₂, PbR*₂, and the like, where R* is, independently, hydrogen, hydrocarbyl (e.g., C₁-C₁₀), or two or more R* may join together to form a substituted or unsubstituted completely saturated, partially unsaturated, fully unsaturated, or aromatic cyclic or polycyclic ring structure.

In at least one aspect, one or more of R¹, R², or R³ is, independently, methyl, ethyl, n-propyl, isopropyl, n-butyl, isobutyl, tert-butyl, sec-butyl, n-pentyl, isopentyl, sec-pentyl, n-hexyl, isohexyl, sec-hexyl, n-heptyl, isoheptyl, sec-heptyl, n-octyl, isooctyl, sec-octyl, n-nonyl, isononyl, sec-nonyl, n-decyl, isodecyl, or sec-decyl, cyclopentyl, cyclohexyl, phenyl, benzyl, isomers thereof, or derivatives thereof.

Illustrative, but non-limiting, examples of phosphorous-containing compounds include alkylphosphines and/or arylphosphines such as trimethylphosphine, triethylphosphine, tripropylphosphine, tributylphosphine, tripentylphosphine, trihexylphosphine, trioctylphosphine, tricyclohexylphosphine, diethylphosphine, dibutylphosphine, diphenylphosphine, dimethylethylphosphine, triphenylphosphine, isomers thereof, derivatives thereof, and combinations thereof.

When the metallic structure includes a phosphorous group, the phosphorous group originates from a nitrogen-containing compound utilized for the synthesis of the metallic structure. Such nitrogen-containing compounds include, e.g., primary amines, secondary amines, tertiary amines, or combinations thereof. The nitrogen-containing compounds can include an unsubstituted hydrocarbyl or a substituted hydrocarbyl (as described herein) bonded to the nitrogen of the nitrogen-containing compound, where the unsubstituted hydrocarbyl or substituted hydrocarbyl can be saturated or unsaturated, linear or branched, cyclic or acyclic, aromatic or non-aromatic. The nitrogen-containing compound can be an alkylamine. Illustrative, but non-limiting, examples of nitrogen-containing compounds include oleylamine (OLA), octadecylamine (ODA), hexadecylamine (HDA), dodecylamine (DDA), tetradecylamine (TDA), isomers thereof, derivatives thereof, or combinations thereof.

In some aspects, the metallic structure can have an average particle size from about 5 nm to about 2000 μm, such as from about from 50 nm to 200 μm, such as from about from 50 nm to 20 μm, such as from about from 500 nm to 2 μm. For polyhedral particles (e.g., metallic structures described herein), the average particle size is an equivalent edge length as measured by TEM. In some examples, the average particle size can be about 5 nm or more, such as from about 10 nm to about 100 nm, such as from about 15 nm to about 95 nm, 20 nm to about 90 nm, such as from about 25 nm to about 85 nm, such as from about 30 nm to about 80 nm, such as from about 35 nm to about 75 nm, such as from about 40 nm to about 70 nm, such as from about 45 nm to about 65 nm, such as from about 50 nm to about 60 nm, such as from about 50 nm to about 60 nm, such as from about 50 nm to about 55 nm or from about 55 nm to about 60 nm. In some examples, the average particle size can be from about 10 nm to about 400 nm, such as from about 25 nm to about 375 nm, such as from about 50 nm to about 350 nm, such as from about 75 nm to about 325 nm, such as from about 100 nm to about 300 nm, such as from about 125 nm to about 275 nm, such as from about 150 nm to about 250 nm, such as from about 175 nm to about 225 nm, such as from about 175 nm to about 200 nm or from about 200 nm to about 225 nm.

The metallic structure can have an average edge length from about 800 nm to about 50 nm, such as from about 600 nm to about 100 nm, such as from about 400 nm to about 150 nm, such as from about 300 nm to about 200 nm, as determined by TEM. In at least one aspect, the average edge length is from about 3 nm to about 40 nm, such as from about 5 nm to about 30 nm, such as from about 10 nm to about 20 nm.

The metallic structure can have an average edge thickness from about 100 nm to about 5 nm, such as from about 80 nm to about 10 nm, such as from about 60 nm to about 20 nm, such as from about 40 nm to about 30 nm, as determined by TEM. In at least one aspect, the average edge thickness is less than about 5 nm, such as less than about 4 nm, such as less than about 3 nm, such as less than about 2 nm, such as less than about 1 nm.

The metallic structures can include particles and/or crystals that have various three-dimensional shapes (e.g., polyhedra) with a desired number of faces or sides. The number of sides can be in multiples of six starting with about 4 sides, and/or in multiples of eight starting with about 8 faces. The number of sides can be about 6, about 8, about 10, about 12, about 16, about 18, about 20, about 24, about 30, about 40, about 80, about 120, about 150, or about 180 sides.

The metallic structure can be in the form of a core-shell structure where, for example, both the Group 10-11 metal and the Group 8-11 metal(s) are in both the core and the shell. In some examples, the Group 10-11 metal can be mainly distributed around the edge region (or in the shell) of the core-shell structure and the Group 8-11 metal(s) can be mainly in the core of the core-shell structure as determined by elemental mapping using energy dispersive spectroscopy. In some examples, the Group 10-11 metal can be mainly in the core of the core-shell structure and the Group 8-11 metal(s) can be mainly distributed around the edge region (or in the shell) of the core-shell structure as determined by elemental mapping using energy dispersive spectroscopy.

The metallic structure can have a variety of polyhedral structures such as cubic, tetrahedral, octahedral, rhombic dodecahedral, decahedral, icosahedral, triangular prism, hexagonal prism, cuboctahedral, rod-shaped, bar-shaped, wire-shaped (or tube-like), or combinations thereof, as determined by X-ray diffraction. Other polyhedral structures are contemplated. Similarly, when the metallic structure is in the form of a nanoframe, the nanoframe can have a variety of polyhedral structures. In some aspects, the polyhedral nanoframe is a face-centered cubic nanoframe, a cubic nanoframe, a tetrahedral nanoframe, an octahedral nanoframe, a rhombic dodecahedral nanoframe, a decahedral nanoframe, an icosahedral nanoframe, a triangular prism nanoframe, a hexagonal prism nanoframe, a cuboctahedral nanoframe, a rod-shaped nanoframe, a bar-shaped nanoframe, a wire-shaped (or tube-like) nanoframe, or combinations thereof, as determined by X-ray diffraction. Other polyhedral nanoframe structures are contemplated.

The polyhedral nanoframes (metallic structures) described herein can be characterized as having an interior encapsulated by a plurality of facets. The interior can be a partially hollow interior, a substantially hollow interior, or a hollow interior. The polyhedral nanoframe can also have small pores in or among some or all of the facets. In some aspects, the small pores can allow small molecules to enter and reside in the interior or on the inner surface of the polyhedral nanoframe so both the exterior surface and interior surface of the nanoframe can provide a catalytic surface. Each of the facets can be made of a plurality of metal atoms. The facets can be solid or can be porous, having small pores that allow small molecules to pass between the outside of the nanoframe and the at least partially hollow interior.

The facets can include a metal atom from Group 10-11 and/or Group 8-11, such as those metals described above, such as Fe, Ru, Os, Co, Rh, Ir, Ni, Pd, Pt, Cu, Ag, Au, or combinations thereof. In some aspects, the facets include only a single type of metal atom, for example, Pt. In other aspects, two or more different types of metal atoms are included in the facets. In some aspects, one or more of the metals can be atoms from the metal core used in the synthesis of the polyhedral nanoframe. In some aspects, the facets include about 50%, 55%, 60%, 65%, 70%, 75%, 80%, 85%, 90%, 95%, or 100% of a single type of metal atom, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range. As a non-limiting example, the facets comprise Pt atoms, where about 50% or more of the metal atoms of the facets are Pt atoms, such as about 60% to about 95% metal atoms, or about 85% or more metal atoms. The amount of metal atoms of nanoframes are determined by ICP-MS.

The polyhedral nanoframe can have any suitable number of facets. The number of faces can be about 4 faces or more, such as from about 4 facets to about 50 facets, such as from about 8 facets to about 40 facets, such as from about 12 facets to about 30 facets, such as from about 18 facets to about 20 facets. In some aspects, the number of facets can be 4, 8, 12, 15, 18, 20, 24, 30, 40, or 50 facets, though a higher or lower number of facets are contemplated. Each of the foregoing numbers can be preceded by the word “about,” “at least about,” “less than about,” or “more than about,” and any of the foregoing numbers can be used singly to describe an open-ended range or in combination to describe a close-ended range. Alternatively, and in some aspects, the polyhedral nanoframe can have 4, 5, 6, 7, 8, 9, 10, 11, 12, 13, 14, 15, 16, 17, 18, 19, or 20 facets or more. Each of the foregoing numbers can be preceded by the word “about,” “at least about,” “less than about,” or “more than about,” and any of the foregoing numbers can be used singly to describe an open-ended range or in combination to describe a close-ended range. For example, the number of facets can be about 4, more than about 8, or from about 8 to about 20. Other numbers of facets are contemplated.

In some examples, bimetallic structures (for example, bimetallic nanoframes) described herein can have any suitable mass percent (mass %) of Pt and Group 8-11 metal, where the group 8-11 metal is different from Pt. The mass % of the bimetallic structure is based on the total mass % of the Pt and the Group 8-11 metal, the total mass % not to exceed 100 mass %.

In some aspects, an amount of Pt in a bimetallic structure described herein can be about 30 mass % or more, about 99 mass % or less, or combinations thereof, such as from about 30 mass % to about 80 mass %, such as from about 35 mass % to about 75 mass %, such as from about 40 mass % to about 70 mass %, such as from about 45 mass % to about 65 mass %, such as from about 50 mass % to about 55 mass %, though other amounts are contemplated. Any of the foregoing numbers can be used singly to describe an open-ended range or in combination to describe a close-ended range.

In some aspects, an amount of Group 8-11 metal (the Group 8-11 metal that is different from Pt; such as Ni) in a bimetallic structure described herein can be about 20 mass % or more, about 99 mass % or less, or combinations thereof, such as from about 20 mass % to about 70 mass %, such as from about 25 mass % to about 65 mass %, such as from about 30 mass % to about 60 mass %, such as from about 35 mass % to about 55 mass %, such as from about 40 mass % to about 50 mass %, though other amounts are contemplated. Any of the foregoing numbers can be used singly to describe an open-ended range or in combination to describe a close-ended range.

In at least one example, an amount of Pt in the bimetallic structure can be from about 55 mass % to about 65 mass %, such as about 60 mass %; and an amount of Group 8-11 metal that is different from Pt (such as Ni) in the bimetallic structure can be from about 35 mass % to about 65 mass %, such as about 40 mass %.

In some examples, trimetallic structures (for example, trimetallic nanoframes) described herein can have any suitable mass percent (mass %) of Pt, Group 10-11 metal (that is different from Pt), and Group 8-11 metal that is different from Pt and is different from the Group 10-11 metal. The mass % of the trimetallic structure is based on the total mass % of the Pt, the Group 10-11 metal, and the Group 8-11 metal, the total mass % not to exceed 100 mass %.

In some aspects, an amount of Pt in a trimetallic structure described herein can be about 30 mass % or more, about 93 mass % or less, or combinations thereof, such as from about 30 mass % to about 60 mass %, such as from about 35 mass % to about 55 mass %, such as from about 40 mass % to about 50 mass %, such as from about 45 mass % to about 50 mass %, though other amounts are contemplated. Any of the foregoing numbers can be used singly to describe an open-ended range or in combination to describe a close-ended range.

In some aspects, an amount of Group 10-11 metal (the Group 10-11 metal that is different from Pt; such as Ni) in a trimetallic structure described herein can be about 5 mass % or more, about 50 mass % or less, or combinations thereof, such as from about 5 mass % to about 50 mass %, such as from about 10 mass % to about 45 mass %, 15 mass % to about 40 mass %, such as from about 20 mass % to about 35 mass %, such as from about 25 mass % to about 30 mass %, such as from about 40 mass % to about 50 mass %, though other amounts are contemplated. Any of the foregoing numbers can be used singly to describe an open-ended range or in combination to describe a close-ended range.

In some aspects, an amount of Group 8-11 metal (the Group 8-11 metal that is different from Pt and the Group 10-11 metal; such as Cu) in a trimetallic structure described herein can be about 2 mass % or more, about 60 mass % or less, or combinations thereof, such as from about 2 mass % to about 60 mass %, such as from about 5 mass % to about 55 mass %, such as from about 10 mass % to about 50 mass %, such as from about 15 mass % to about 45 mass %, such as from about 20 mass % to about 40 mass %, 25 mass % to about 35 mass %, such as from about 25 mass % to about 30 mass %, though other amounts are contemplated. Any of the foregoing numbers can be used singly to describe an open-ended range or in combination to describe a close-ended range.

In at least one example, an amount of Pt in the trimetallic structure can be from about 55 mass % to about 65 mass %, such as about 60 mass %; an amount of the Group 10-11 metal (such as Ni) can be from about 15 mass % to about 30 mass %, such as about 23 mass %; and an amount of the Group 8-11 metal (such as Cu) can be from about 20 mass % to about 30 mass %, such as about 26 mass %.

Metallic structures described herein can be characterized as having a mass activity (in units of A/mg (Pt)) of 0.2, 0.23, 0.3, 0.4, 0.44, 0.5, 0.65, 0.69, 1, 1.5, 2, 3, 3.5, 4, 4.5, 5, 5.5, 6, 6.5, 7, 7.5, 8, 8.5, 9, 9.5, 10, 11, 12, 13, 13.8, or 14, though higher or lower mass activities are contemplated. When the metal is not Pt, the units are A/mg (metal). Each of the foregoing numbers can be preceded by the word “about,” “at least about,” “less than about,” or “more than about,” and any of the foregoing numbers can be used singly to describe an open-ended range or in combination to describe a close-ended range. For example, the mass activity (in units of A/mg (Pt)) can be about 0.44, at least about 0.5, from about 1 to about 9, from about 0.23 to about 13.8. The mass activity is determined at 0.9V with a reference to a reversible hydrogen electrode (V_{RHE}).

Metallic structures described herein can be characterized as having a surface active area (in units of m²/mg (Pt)) that is from about 70 to about 388, such as from about 100 to about 300, such as from about 150 to about 250, though higher or lower values are contemplated. Any of the foregoing numbers can be used singly to describe an open-ended range or in combination to describe a close-ended range.

As discussed above, metallic structures described herein can be at least at least partially hollow, substantially hollow, or hollow as determined by HAADF-STEM. The metallic structure can be characterized as a nanoframe as determined by HAADF-STEM. Although aspects detailed herein are related to nanoscale materials (e.g., nanoparticles, nanocrystals, and nanoframes), larger or smaller structures are contemplated such as microparticles, macroparticles, microcrystals, macrocrystals, microframes, and/or macroframes.

In some aspects, metallic structures described herein has an X-ray diffraction (XRD) pattern showing peaks at {111}, {200}, {220}, and/or {311}. Metallic structures can be face-centered cubic, though other morphologies are contemplated.

In at least one aspect, metallic structures described herein can facilitate conversion reactions. In some aspects, one or more metallic structures described herein can be at least a portion of a catalyst composition. The catalyst composition can facilitate conversion reactions.

Catalysts compositions described herein can include at least two components. The first component comprises one or more metallic structures (e.g., a bimetallic nanoframe, a trimetallic nanoframe, or combinations thereof). The second component comprises a carbon source. The catalyst composition can comprise one or more metallic structures chemically bonded to the carbon source. In some aspects, the one or more metallic structures is chemically bonded to a surface of the carbon support, such that the catalyst composition comprises a carbon-supported metallic structure. As described above, the carbon support can include carboxyl groups (—COOH) and/or ions thereof (—COO⁻) that can bond to one or more metals of the metallic structures.

### Processes

### Carbon-Supported Bimetallic Nanoframes

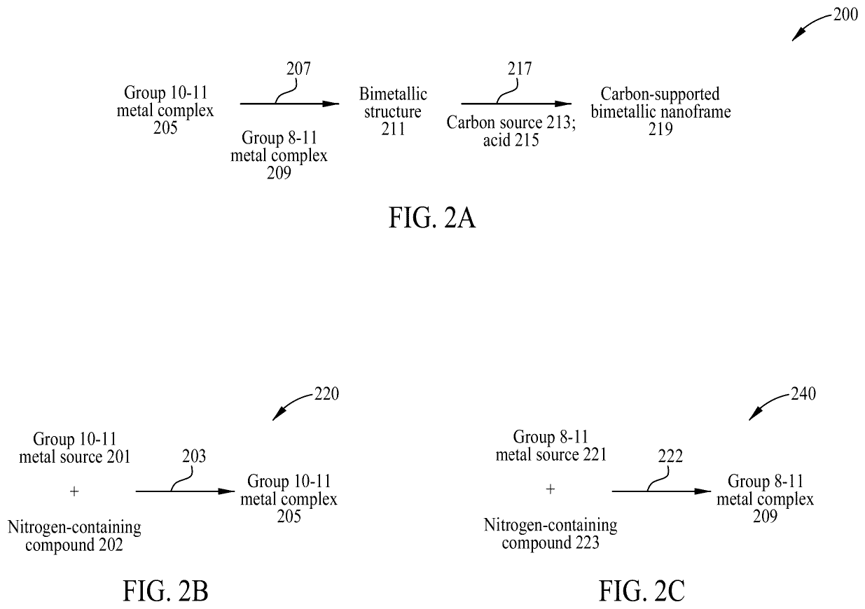

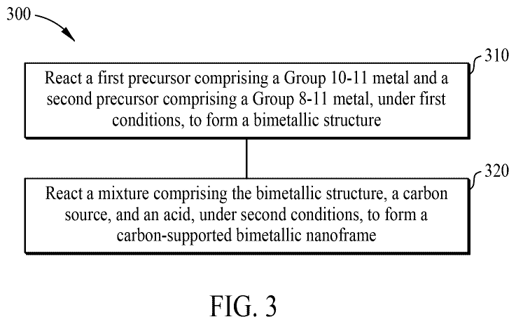

Aspects described herein generally relate to processes for forming carbon-supported bimetallic structures. FIGS. 2A, 2B, and 2C show reaction diagrams 200, 220, and 240, respectively, illustrating selected operations for forming a carbon-supported bimetallic structure (e.g., a carbon-supported bimetallic nanoframe). The bimetallic structure can be at least partially hollow, substantially hollow, or hollow and/or characterized as a nanoframe, such as those described above. FIG. 3 is a flowchart showing selected operations of a process 300 for forming a carbon-supported bimetallic nanoframe according to at least one aspect of the present disclosure.

The process 300 includes reacting a first precursor with a second precursor under first conditions 207 effective to form a bimetallic structure 211 at operation 310. The first precursor includes a Group 10-11 metal and may be in the form of a Group 10-11 metal complex 205. The second precursor includes a Group 8-11 metal and may be in the form of a Group 8-11 metal complex 209.

Referring to FIG. 2B, the Group 10-11 metal complex 205 of the first precursor can be made by introducing a Group 10-11 metal source 201 with a nitrogen-containing compound 202 under conditions 203 effective to form the Group 10-11 metal complex 205. The Group 10-11 metal complex 205 can be, for example, a metal amine such as a platinum amine. The Group 10-11 metal source 201 includes a Group 10-11 metal, for example, Ni, Pd, Pt, Cu, Ag, Au, or combinations thereof. The Group 10-11 metal source 201 can further include one or more ligands such as halide (for example, I⁻, Br⁻, Cl⁻, or F⁻), acetylacetonate (O₂C₅H₇⁻), hydride (H⁻), SCN⁻, NO₂⁻, NO₃⁻, N₃⁻, OH⁻, oxalate (C₂O₄²⁻), H₂O, acetate (CH₃COO⁻), O₂⁻, CN⁻, OCN⁻, OCN⁻, CNO⁻, NH₂⁻, NH²⁻, NC⁻, NCS⁻, N(CN)₂⁻, pyridine (py), ethylenediamine (en), 2,2′-bipyridine (bipy), PPh₃, or combinations thereof. In some aspects, the Group 10-11 metal of the Group 10-11 metal source 201 includes platinum, copper, and/or another Group 10-11 metal. Illustrative, but non-limiting, examples of the Group 10-11 metal source 201 include platinum halides, platinum acetates, platinum nitrates, other suitable platinum species, copper acetates, copper halides, copper nitrates, and/or other suitable copper species. Hydrates are also contemplated. Examples of the Group 10-11 metal source 201 include, but are not limited to, hexachloroplatinic acid (or hydrates thereof, for example, H₂PtCl₆·6H₂O), platinum chloride (PtCl₄), potassium platinum(II) chloride (K₂PtCl₄), platinum(II) acetate (Pt(CH₃CO₂)₂), platinum(IV) acetate (Pt(CH₃CO₂)₄), sodium hexachloroplatinate hexahydrate (Na₂PtCl₆·6H₂O), and platinum(II) acetylacetonate (Pt(C₅H₇O₂)₂).

The nitrogen-containing compound 202 can be those described above for, though other nitrogen-containing compounds are contemplated. Illustrative, but non-limiting, examples of the nitrogen-containing compound 202 include OLA, ODA, HDA, DDA, TDA, or combinations thereof. The nitrogen-containing compound 202 can also be utilized as a solvent. When desired, a solvent such as octadecene, phenyl ether, benzyl ether, or combinations thereof can additionally, or alternatively, be used. In some examples, the molar ratio of Group 10-11 metal source 201 to nitrogen-containing compound 202 is 1:1000, 1:900, 1:800, 1:700, 1:600, 1:500, 1:400, 1:300, 1:200, 1:100, 1:90, 1:80, 1:70, 1:60, 1:50, 1:40, 1:30, 1:20, 1:10, 1:5, 1:3, 1:2, or 1:1, though higher or lower molar ratios are contemplated. Each of the foregoing numbers can be preceded by the word “about,” “at least about,” “less than about,” or “more than about,” and any of the foregoing numbers can be used singly to describe an open-ended range or in combination to describe a close-ended range. For example, the molar ratio of Group 10-11 metal source 201 to nitrogen-containing compound 202 is about 1:10, more than about 1:50 (for example, 1:1), or from about 1:20 to about 1:10. In some examples, the molar ratio of Group 10-11 metal source 201 to nitrogen-containing compound 202 is from about 1:1000 to about 1:1, such as from about 1:500 to about 1:1, such as from about 1:100 to about 1:1, such as from about 1:50 to about 1:1 based on the starting material molar ratio used for the reaction. In some aspects, the molar ratio of copper source to nitrogen-containing compound is from about 1:20 to about 1:1, such as from about 1:10 to about 1:1, such as from about 1:4 to about 1:1, such as from about 1:2 to about 1:1. The molar ratio of Group 10-11 metal source 201 to nitrogen-containing compound 202 is based on the starting material molar ratio used for the reaction.

Conditions 203 effective to form the Group 10-11 metal complex 205 (for example, the metal amine such as the platinum amine) can include a reaction temperature and a reaction time. The reaction temperature to form the Group 10-11 metal complex 205 can be greater than about 40° C., such as greater than about 60° C., such as greater than about 80° C., such as from about 100° C. to about 320° C., such as from about 110° C. to about 310° C., such as from about 120° C. to about 300° C., such as from about 130° C. to about 290° C., such as from about 140° C. to about 280° C., such as from about 150° C. to about 270° C., such as from about 160° C. to about 260° C., such as from about 170° C. to about 250° C., such as from about 180° C. to about 240° C., such as from about 190° C. to about 230° C., such as from about 200° C. to about 220° C. In some aspects, the reaction temperature to form the Group 10-11 metal complex 205 can be from about 150° C. to about 250° C. or from about 180° C. to about 240° C. Higher or lower temperatures can be used when appropriate. The reaction time to form the Group 10-11 metal complex 205 can be about 1 minute (min) or more or about 24 h or less, such as from about 1 min to about 12 h, such as from about 5 min to about 6 hours (h), such as from about 10 min to about 5.5 h, such as from about 15 min to about 5 h, such as from about 30 min to about 4 h, such as from about 45 min to about 3 h, such as from about 1 h to about 2 h. The reaction time to form the Group 10-11 metal complex 205 can be more or less depending on, for example, the level of conversion desired. Any reasonable pressure can be used during formation of the Group 10-11 metal complex 205.

Conditions 203 effective to form the Group 10-11 metal complex 205 (for example, the copper amine or nickel amine) can include stirring, mixing, and/or agitation. Conditions 203 can optionally include utilizing a non-reactive gas, such as N₂ and/or Ar. For example, a mixture of the Group 10-11 metal source 201 and the nitrogen-containing compound 202 can be placed under these or other non-reactive gases to degas various components or otherwise remove oxygen from the reaction mixture.

In some aspects, the Group 10-11 metal complex 205 can be kept in the form of a stock solution/suspension for use in operation 310. In other aspects, the reaction product comprising the Group 10-11 metal complex 205 can be subjected to filtration, separation, cleaning, quenching, washing, purification, and/or other suitable processes to remove undesired components and isolate the Group 10-11 metal complex 205 from the other components of the reaction mixture. For example, the reaction product comprising the Group 10-11 metal complex 205 (which may be in the form of particles) can be centrifuged to separate the Group 10-11 metal complex 205 from the mixture. Additionally, or alternatively, the Group 10-11 metal complex 205 can be washed with polar solvent(s), such as water, acetone, ethanol, methanol, or combinations thereof, and/or non-polar solvent(s), such as hexane, pentane, toluene, or combinations thereof. Other solvents for washing can include ether solvents such as diethyl ether and tetrahydrofuran; chlorocarbon solvents such as dichloromethane and chloroform; as well as ethyl acetate, dimethylformamide, acetonitrile, benzene, isopropanol, n-butanol, n-propanol. Mixtures of two or more of these solvents, in suitable proportions, can be utilized for washing, purifying, or otherwise separating the Group 10-11 metal complex 205 from other components in the reaction mixture. As an example, a solvent or a mixture of solvents can be added to the Group 10-11 metal complex 205 and the resultant mixture centrifuged. The supernatant can be discarded and the remaining pellet can be dispersed in a suitable solvent or mixture of solvents. The resultant pellet and solvent(s) can then be centrifuged to obtain the Group 10-11 metal complex 205. In these and other aspects, the pellet comprising the Group 10-11 metal complex 205 can be re-solubilized or re-suspended in a nitrogen-containing compound such as those described above.

Referring to FIG. 2C, the Group 8-11 metal complex 209 of the second precursor can be formed by introducing a Group 8-11 metal source 221 with a nitrogen-containing compound 223 under conditions 222 effective to form the Group 8-11 metal complex 209. The nitrogen-containing compound 223 can be the same or different than the nitrogen-containing compound 202. The Group 8-11 metal source 221 includes a Group 8-11 metal of the periodic table of the elements, such as Fe, Ru, Os, Co, Rh, Ir, Ni, Pd, Pt, Cu, Ag, Au, or combinations thereof, such as Fe, Co, Ni, Pd, Pt, Cu, Ag, Au, or combinations thereof. The Group 8-11 metal source 221 can further include one or more ligands such as halide (I⁻, Br⁻, Cl⁻, or F⁻), acetylacetonate (O₂C₅H₇⁻), hydride (H⁻), SCN⁻, NO₂⁻, NO₃⁻, N₃⁻, OH⁻, oxalate (C₂O₄²⁻), H₂O, acetate (CH₃COO⁻), O₂⁻, CN⁻, OCN⁻, OCN⁻, CNO⁻, NH₂⁻, NH²⁻, NC⁻, NCS⁻, N(CN)₂⁻, pyridine (py), ethylenediamine (en), 2,2′-bipyridine (bipy), PPh₃, or combinations thereof. In some aspects, the Group 8-11 metal source 221 includes metal acetates, metal acetalacetonates, metal halides, metal nitrates, and/or other Group 8-11 metal species. Illustrative, but non-limiting, examples of the Group 8-11 metal source 221 include nickel (II) acetylacetonate, nickel (II) nitrate, nickel (II) chloride, cobalt (II) acetylacetonate, iron (II) acetylacetonate, hydrates thereof, and combinations thereof. Examples of the Group 8-11 metal source 221 can also include Au, Ag, and Pd having the same or similar ligands, and combinations thereof. Hydrates of one or more of the aforementioned materials are also contemplated.

Conditions 222 effective to form the Group 8-11 metal complex 209 (for example, the Group 8-11 metal amine) of the third precursor can include similar conditions for forming the Group 10-11 metal complex 205 described above with respect to conditions 203.

Referring back to FIG. 2A, the Group 10-11 metal complex 205 and the Group 8-11 metal complex 209 are introduced, under first conditions 207, to form the bimetallic structure 211 at operation 310. For operation 310, the molar ratio of the first precursor (for example, the Group 10-11 metal complex 205) to second precursor (for example, the Group 8-11 metal complex 209) can be adjusted as desired. In some examples, the molar ratio of the Group 10-11 metal complex 205 to the Group 8-11 metal complex 209 is 100:1, 90:1, 80:1, 70:1, 60:1, 50:1, 40:1, 30:1, 20:1, 10:1, 5:1, 3:1, 2:1, 1:1, 1:2, 1:3, 1:5, 1:10, 1:20, 1:30, 1:40, 1:50, 1:60, 1:70, 1:80, 1:90, or 1:100, though other molar ratios are contemplated. Each of the foregoing numbers can be preceded by the word “about,” “at least about,” “less than about,” or “more than about,” and any of the foregoing numbers can be used singly to describe an open-ended range or in combination to describe a close-ended range. For example, the molar ratio the Group 10-11 metal complex 205 to the Group 8-11 metal complex 209 is about 5:1, from about 10:1 to about 2:1, or at least about 1:1. In some examples, the molar ratio of the Group 10-11 metal complex 205 to the Group 8-11 metal complex 209 is from about 100:1 to about 1:100, such as from about 50:1 to about 1:50, such as from about 20:1 to about 1:20, such as from about 10:1 to about 1:10, such as from about 5:1 to about 1:5, such as from about 3:1 to about 1:3, such as about 1:1 or from about such as from about 1:1 to about 1:2. The molar ratio is determined based on the starting material molar ratio used for the reaction.

The first conditions 207 of operation 310 can include an operating temperature and a duration of time. The operating temperature (° C.) of operation 310 can be 50, 75, 100, 125, 150, 175, 200, 225, 250, 275, 300, 325, 350, 375, 400, though higher or lower temperatures are contemplated. Each of the foregoing numbers can be preceded by the word “about,” “at least about,” “less than about,” or “more than about,” and any of the foregoing numbers can be used singly to describe an open-ended range or in combination to describe a close-ended range. For example, the temperature can be about 400° C. or less, about 150° C. to about 275° C., or more than about 150° C. In some aspects, the operating temperature of operation 310 is about 400° C. or less, such as from about 50° C. to about 400° C., such as from about 75° C. to about 375° C., such as from about 100° C. to about 350° C., such as from about 125° C. to about 325° C., such as from about 150° C. to about 300° C., such as from about 175° C. to about 275° C., such as from about 200° C. to about 250° C., such as from about 200° C. to about 225° C. In some aspects, the operating temperature of operation 310 can be set to a temperature of about 80° C. to about 320° C., such as from about 100° C. to about 150° C. or from about 180° C. to about 320° C. In some aspects, a combination of two or more temperatures can be utilized. The time for forming the bimetallic structure 211 (for example, the first conditions 207) of operation 310 can be about 1 min or more or about 24 h or less, such as from about 5 min to about 6 h, such as from about 10 min to about 1 h, though greater or lesser periods of time are contemplated. Operation 310 can include stirring, mixing, and/or agitating the mixture to ensure, for example, homogeneity of the mixture. Operation 310 can be performed using a non-reactive gas (such as N₂ and/or Ar) to remove or substantially remove oxygen from the mixing environment. Suitable operating pressures can be utilized for operation 310. In some aspects, and prior to introducing the first precursor with the second precursor, the second precursor can be mixed with a solvent. The solvent can be, or include, a nitrogen-containing compound, such as those described above. Additionally, or alternatively, other suitable solvents can be used.

As such, the bimetallic structure 211 is formed. This bimetallic structure 211 can be a bimetallic nanoparticle such as a bimetallic polyhedral nanoparticle.

The process 300 further includes reacting a mixture comprising the bimetallic structure 211, a carbon source 213, and an acid 215 to form a catalyst composition comprising a carbon-supported bimetallic nanoframe 219 at operation 320. The catalyst composition can be those described above. Operation 320 can convert the solid bimetallic structure to an at least partially hollow bimetallic structure (for example, a bimetallic nanoframe). Operation 320 can cause the bimetallic nanoframe to be chemically bonded to the carbon source, for example, chemically bonded to a surface of the carbon support. As described above, the carbon support can include carboxyl groups (—COOH) and/or ions thereof (—COO⁻) that can bond to one or more metals of the metallic structures.

The resulting carbon-supported bimetallic nanoframe 219 can have a higher concentration of Pt than the concentration of Pt in the bimetallic structure 211. For example, the carbon-supported bimetallic nanoframe 219 formed from operation 320 can have a higher molar ratio of Pt to Group 8-11 metal (such as Ni) than the molar ratio of Pt to Group 8-11 metal of the bimetallic structure 211 formed at operation 310. While not wishing to be bound by any theory, it is believed that certain atoms in the bimetallic structure 211 can be oxidized and removed by use of the acid and hollow nanostructures (for example, bimetallic nanoframe) are formed due to the those atoms diffusing from the interior to the exterior.

Molar ratios and mass percents for the metals present in the bimetallic nanoframe portion of the carbon-supported catalyst are described above.

The carbon source 213 can be any suitable carbon source such as, for example, a material comprising carbon black (for example Vulcan carbon), carbon nanotube, carbon nanofiber, mesoporous carbon, carbon nanowire, acetylene black, graphite, graphene, graphene oxide, fullerene, or combinations thereof, though other carbon sources are contemplated.

Operation 320 can include second conditions 217. Second conditions 217 can include immersing, soaking, or otherwise subjecting the bimetallic structure 211 and the carbon source 213 to acid 215. The acid can be any suitable acid such as, for example, acetic acid, carbonic acid, propionic acid, phosphoric acid (H₃PO₄), sulfuric acid (H₂SO₄), nitric acid (HNO₃), perchloric acid (HClO₄), hydrochloric acid (HCl), or combinations thereof. The acid may be provided as a solution, for example, an aqueous solution. In some aspects, the concentration of acid in the aqueous solution is from about 0.01 M to about 10 M, such as from about 0.1 M to about 2 M, such as from about 0.5 M to about 1.5 M, such as from about 1 M to about 1.25 M. Any of the foregoing numbers can be used singly to describe an open-ended range or in combination to describe a close-ended range.

In some examples, a molar ratio of bimetallic structure 211 to acid 215 is from about 1:500 to about 1:1, such as from about 1:200 to about 1:1, such as from about 1:50 to about 1:1, such as from about 1:20 to about 1:1 based on the starting material molar ratio used for the reaction. In some aspects, the molar ratio of bimetallic structure 211 to acid is from about 1:10 to about 1:1, such as from about 1:5 to about 1:1, such as from about 1:2 to about 1:1 based on the starting material molar ratio used for the reaction. Any of the foregoing numbers can be used singly to describe an open-ended range or in combination to describe a close-ended range.

A weight ratio of bimetallic structure 211 (catalyst) to carbon source 213 used to form the carbon-supported bimetallic nanoframe can be from about 5:1 to about 1:10, such as from about 4:1 to about 1:8, such as from about 3:1 to about 1:5, or from about 2:1 to about 2:3, or from about 1:1 to about 1:2, such as about 1:1, about 2:1, or about 2:3, though other weight ratios are contemplated. In some examples, the carbon-supported bimetallic nanoframe 219. Any of the foregoing numbers can be used singly to describe an open-ended range or in combination to describe a close-ended range.

Second conditions 217 effective to form the carbon-supported bimetallic nanoframe 219 can include a reaction temperature and a reaction time. The reaction temperature to form the carbon-supported bimetallic nanoframe 219 can be greater than about −10° C., such as greater than about 0° C., such as greater than about 15° C., such as from about 20° C. to about 100° C., such as from about 30° C. to about 90° C., such as from about 40° C. to about 70° C. Higher or lower temperatures can be used when appropriate. The reaction time to form the carbon-supported bimetallic nanoframe 219 can be about 30 seconds or more and/or about 72 h or less, such as from about 1 h to about 24 h, such as from about 2 h to about 16 h, such as from about 5 h to about 10 h. Any reasonable pressure can be used during formation of the carbon-supported bimetallic nanoframe 219.

Second conditions 217 effective to form the carbon-supported bimetallic nanoframe 219 can include stirring, mixing, and/or agitation via, e.g., sonication. Second conditions 217 effective to form the carbon-supported bimetallic nanoframe 219 can optionally include utilizing a non-reactive gas, such as N₂ and/or Ar. For example, the bimetallic structure 211, the carbon source 213, and the acid 215 can be placed under these or other non-reactive gases to, e.g., degas various components or otherwise remove oxygen from the reaction mixture.

In some aspects, the reaction product comprising the carbon-supported bimetallic nanoframe 219 can be subjected to filtration, separation, cleaning, quenching, washing, purification, and/or other suitable processes to remove undesired components and isolate the carbon-supported bimetallic nanoframe 219 from the other components of the reaction mixture. For example, the reaction product comprising the carbon-supported bimetallic nanoframe 219 (which may be in the form of particles) can be centrifuged to separate the carbon-supported bimetallic nanoframe 219 from the mixture. Additionally, or alternatively, the carbon-supported bimetallic nanoframe 219 can be washed with polar solvent(s), such as water, acetone, ethanol, methanol, or combinations thereof, and/or non-polar solvent(s), such as hexane, pentane, toluene, or combinations thereof. Other solvents for washing can include ether solvents such as diethyl ether and tetrahydrofuran; chlorocarbon solvents such as dichloromethane and chloroform; as well as ethyl acetate, dimethylformamide, acetonitrile, benzene, isopropanol, n-butanol, n-propanol. Mixtures of two or more of these solvents, in suitable proportions, can be utilized for washing, purifying, or otherwise separating the carbon-supported bimetallic nanoframe 219 from other components in the reaction mixture. As an example, a solvent or a mixture of solvents can be added to the carbon-supported bimetallic nanoframe 219 and the resultant mixture centrifuged. The supernatant can be discarded and the remaining pellet can be dispersed in a suitable solvent or mixture of solvents. The resultant pellet and solvent(s) can then be centrifuged to obtain the carbon-supported bimetallic nanoframe 219. In these and other aspects, the pellet comprising the carbon-supported bimetallic nanoframe 219 can be re-solubilized or re-suspended in a suitable solvent such as water or those described above.

Characteristics of the carbon-supported bimetallic nanoframe 219 formed from operation 320 are described above.

### Carbon-Supported Trimetallic Nanoframes

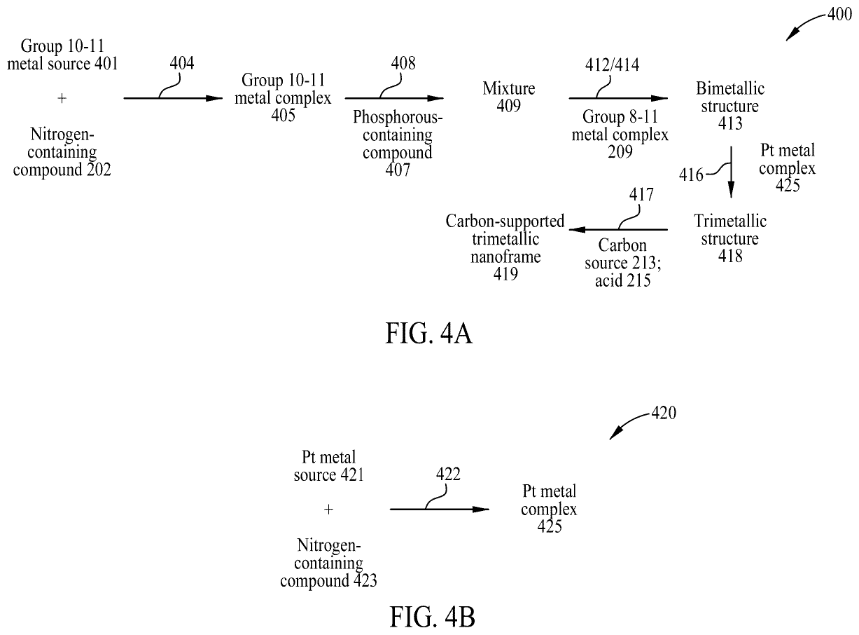

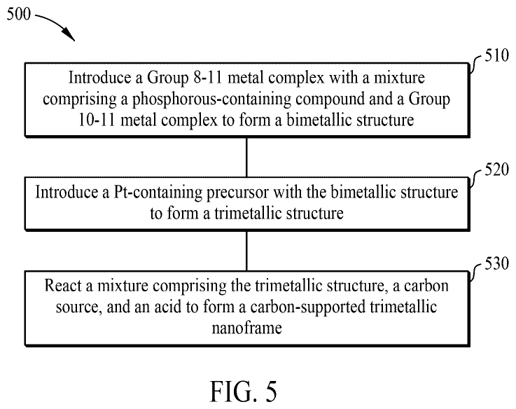

Aspects described herein generally relate to processes for forming carbon-supported trimetallic structures. FIGS. 4A and 4B show reaction diagrams 400 and 420, respectively, illustrating selected operations for forming a carbon-supported trimetallic structure (e.g., a carbon-supported trimetallic nanoframe). The trimetallic structure can be at least partially hollow, substantially hollow, or hollow and/or characterized as a nanoframe, such as those described above. FIG. 5 is a flowchart showing selected operations of a process 500 for forming a carbon-supported trimetallic nanoframe according to at least one aspect of the present disclosure

The process 500 includes introducing a Group 8-11 metal complex with a mixture comprising a phosphorous-containing compound and Group 10-11 metal complex to form a bimetallic structure at operation 510.

The Group 10-11 metal complex 405 can be made by, e.g., introducing a Group 10-11 metal source 401 with a nitrogen-containing compound 202 under conditions 404 effective to form the Group 10-11 metal complex 405. The Group 10-11 metal complex 405 can be, e.g., a copper amine or a nickel amine. The Group 10-11 metal source 401 can include one or more ligands such as halide (e.g., I⁻, Br⁻, Cl⁻, or F⁻), acetylacetonate (O₂C₅H₇⁻), hydride (H⁻), SCN⁻, NO₂⁻, NO₃⁻, N₃⁻, OH⁻, oxalate (C₂O₄²⁻), H₂O, acetate (CH₃COO⁻), O₂⁻, CN⁻, OCN⁻, OCN⁻, CNO⁻, NH₂⁻, NH²⁻, NC⁻, NCS⁻, N(CN)₂⁻, pyridine (py), ethylenediamine (en), 2,2′-bipyridine (bipy), PPh₃, or combinations thereof. In some aspects, the Group 10-11 metal of the Group 10-11 metal source 401 includes copper and/or nickel. Illustrative, but non-limiting, examples of the Group 10-11 metal source 401 include copper acetates, copper halides, copper nitrates, other suitable copper species, nickel acetates, nickel halides, nickel nitrates, and/or other suitable nickel species.

The nitrogen-containing compound 202 can be those described above. Illustrative, but non-limiting, examples of the nitrogen-containing compound 202 include OLA, ODA, HDA, DDA, TDA, or combinations thereof. The nitrogen-containing compound 202 can be utilized as a solvent. When desired, a solvent such as octadecene, phenyl ether, benzyl ether, or combinations thereof can additionally, or alternatively, be used. In some examples, the molar ratio of Group 10-11 metal source 401 to nitrogen-containing compound 202 is from about 1:1000 to about 1:1, such as from about 1:500 to about 1:1, such as from about 1:100 to about 1:1, such as from about 1:50 to about 1:1 based on the starting material molar ratio used for the reaction. In some aspects, the molar ratio of Group 10-11 metal source 401 to nitrogen-containing compound 202 is from about 1:20 to about 1:1, such as from about 1:10 to about 1:1, such as from about 1:4 to about 1:1, such as from about 1:2 to about 1:1 based on the starting material molar ratio used for the reaction.

Conditions 404 effective to form the Group 10-11 metal complex 405 (e.g., a copper amine or nickel amine) can include a reaction temperature and a reaction time. The reaction temperature to form the Group 10-11 metal complex 405 can be greater than about 40° C., such as greater than about 60° C., such as greater than about 80° C., such as from about 100° C. to about 320° C., such as from about 110° C. to about 310° C., such as from about 120° C. to about 300° C., such as from about 130° C. to about 290° C., such as from about 140° C. to about 280° C., such as from about 150° C. to about 270° C., such as from about 160° C. to about 260° C., such as from about 170° C. to about 250° C., such as from about 180° C. to about 240° C., such as from about 190° C. to about 230° C., such as from about 200° C. to about 220° C. In some aspects, the reaction temperature to form the Group 10-11 metal complex 405 can be from about 150° C. to about 250° C. or from about 180° C. to about 240° C. Higher or lower temperatures can be used when appropriate. The reaction time to form the Group 10-11 metal complex 405 can be about 1 minute (min) or more or about 24 h or less, such as from about 1 min to about 12 h, such as from about 5 min to about 6 hours (h), such as from about 10 min to about 5.5 h, such as from about 15 min to about 5 h, such as from about 30 min to about 4 h, such as from about 45 min to about 3 h, such as from about 1 h to about 2 h. The reaction time to form the Group 10-11 metal complex 405 can be more or less depending on, e.g., the level of conversion desired. Any reasonable pressure can be used during formation of the Group 10-11 metal complex 405.

Conditions 404 effective to form the Group 10-11 metal complex 405 (e.g., the copper amine or nickel amine) can include stirring, mixing, and/or agitation. Conditions 404 effective to form the Group 10-11 metal complex 405 can optionally include utilizing a non-reactive gas, such as N₂ and/or Ar. For example, a mixture of the Group 10-11 metal source 401 and the nitrogen-containing compound 202 can be placed under these or other non-reactive gases to, e.g., degas various components or otherwise remove oxygen from the reaction mixture.

In some aspects, the Group 10-11 metal complex 405 can be kept in the form of a stock solution/suspension for use in operation 510. In other aspects, the reaction product comprising the Group 10-11 metal complex 405 can be subjected to filtration, separation, cleaning, quenching, washing, purification, and/or other suitable processes to remove undesired components and isolate the Group 10-11 metal complex 405 from the other components of the reaction mixture. For example, the reaction product comprising the Group 10-11 metal complex 405 (which may be in the form of particles) can be centrifuged to separate the Group 10-11 metal complex 405 from the mixture. Additionally, or alternatively, the Group 10-11 metal complex 405 can be washed with polar solvent(s), such as water, acetone, ethanol, methanol, or combinations thereof, and/or non-polar solvent(s), such as hexane, pentane, toluene, or combinations thereof. Other solvents for washing can include ether solvents such as diethyl ether and tetrahydrofuran; chlorocarbon solvents such as dichloromethane and chloroform; as well as ethyl acetate, dimethylformamide, acetonitrile, benzene, isopropanol, n-butanol, n-propanol. Mixtures of two or more of these solvents, in suitable proportions, can be utilized for washing, purifying, or otherwise separating the Group 10-11 metal complex 405 from other components in the reaction mixture. As an example, a solvent or a mixture of solvents can be added to the Group 10-11 metal complex 405 and the resultant mixture centrifuged. The supernatant can be discarded and the remaining pellet can be dispersed in a suitable solvent or mixture of solvents. The resultant pellet and solvent(s) can then be centrifuged to obtain the Group 10-11 metal complex 405. In these and other aspects, the pellet comprising the Group 10-11 metal complex 405 can be re-solubilized or re-suspended in a nitrogen-containing compound such as those described above.

Operation 510 includes forming a mixture 409 of the Group 10-11 metal complex 405 and the phosphorous-containing compound 407. The phosphorous-containing compound can be one or more of those described above.

The mixture 409 can be formed under conditions 408 that includes an operating temperature and a duration of time. The operating temperature of conditions 408 can be set to about 400° C. or less, such as from about 50° C. to about 400° C., such as from about 75° C. to about 375° C., such as from about 100° C. to about 350° C., such as from about 125° C. to about 325° C., such as from about 150° C. to about 300° C., such as from about 175° C. to about 275° C., such as from about 200° C. to about 250° C., such as from about such as from about 200° C. to about 225° C. In some aspects, the operating temperature of conditions 408 can be set to a temperature of about 100° C. to about 150° C. or from about 180° C. to about 320° C. Higher or lower temperatures can be used when appropriate. The time for forming the mixture 409 can be about 1 min or more or about 24 h or less, such as from about 5 min to about 6 h, such as from about 10 min to about 1 h, though greater or lesser periods of time are contemplated. Conditions 408 can include stirring, mixing, and/or agitating the mixture to ensure, e.g., homogeneity of the mixture. Conditions 408 can be performed using a non-reactive gas (e.g., N₂ and/or Ar) to, e.g., remove or substantially remove oxygen from the mixing environment. Suitable operating pressures can be utilized for conditions 408.

Additionally, the molar ratio of the Group 10-11 metal complex 405 to the phosphorous-containing compound 407 can be adjusted as desired. In some examples, the molar ratio of the Group 10-11 metal complex 405 to the phosphorous-containing compound 407 is from about 50:1 to about 1:100, such as from about 20:1 to about 1:50, such as from about 10:1 to about 1:10 based on the starting material molar ratio used for the reaction. In some aspects, the molar ratio of the Group 10-11 metal complex 405 to the phosphorous-containing compound 407 is from about 5:1 to about 1:5, such as from about 3:1 to about 1:3, such as from about 1:1 to about 1:2 based on the starting material molar ratio used for the reaction.

In some aspects, and prior to making a mixture of the Group 10-11 metal complex 405 and the phosphorous-containing compound 407, the phosphorous-containing compound 407 can be mixed with a solvent. The solvent can be, or include, a nitrogen-containing compound, such as those described above. Additionally, or alternatively, other suitable solvents can be used. The solvent(s) and the phosphorous-containing compound 407 can be heated under a non-reactive gas (e.g., N₂ and/or Ar) at a temperature of about 50° C. or more to about 400° C. or less, such as from about 75° C. to about 375° C., such as from about 100° C. to about 350° C., such as from about 125° C. to about 325° C., such as from about 150° C. to about 300° C., such as from about 175° C. to about 275° C., such as from about 200° C. to about 250° C., such as from about such as from about 200° C. to about 225° C., for a suitable time such as about 24 h or less, such as about 12 h or less, such as about 5 h or less, such as about 1 h or less, such as about 30 min or less, such as about 10 min or less and under suitable pressures. In these and other aspects, the Group 10-11 metal complex 405 is then added to the phosphorous-containing compound 407 and optional solvent. The resulting mixture can then be cooled to those temperatures of the first conditions described above, such as from about 50° C. to about 400° C., such as from about 75° C. to about 375° C., such as from about 100° C. to about 350° C., such as from about 125° C. to about 325° C., such as from about 150° C. to about 300° C., such as from about 175° C. to about 275° C., such as from about 200° C. to about 250° C., such as from about such as from about 200° C. to about 225° C. for a suitable time (described above), under suitable pressures, and optionally under a non-reactive gas (e.g., N₂ and/or Ar).

To form the bimetallic structure in operation 510, a Group 8-11 metal complex 209 can be introduced to the mixture 409. In FIG. 4A, conditions effective to form the bimetallic structure 413 are designated by numeral 412/414.

Amounts of the Group 8-11 metal complex 209 can be adjusted relative to one or more components of the mixture 409, e.g., the Group 10-11 metal complex 405 and the phosphorous-containing compound 407. For example, the molar ratio of Group 8-11 metal complex 209 to the phosphorous-containing compound 407 can be from about 1:500 to about 1:50, such as from about 1:250 to about 1:70, such as from about 1:120 to about 1:100 based on the starting material molar ratio used for the reaction. In some aspects, the molar ratio of Group 8-11 metal complex 209 to the phosphorous-containing compound 407 can be from about 1:50 to about 1:1, such as from about 1:20 to about 1:5, such as from about 1:10 to about 1:8 based on the starting material molar ratio used for the reaction.

Additionally, or alternatively, the molar ratio of the Group 8-11 metal complex 209 to the Group 10-11 metal complex 405 can be from about 100:1 to about 1:10, such as from about 80:1 to about 1:20, such as from about 50:1 to about 1:30 based on the starting material molar ratio used for the reaction. In some aspects, the molar ratio of the Group 8-11 metal complex 209 to the Group 10-11 metal complex 405 can be from about 1:1 to about 1:10, such as from about 1:2 to about 1:7, such as from about 1:3 to about 1:4 based on the starting material molar ratio used for the reaction.

When desired, a solvent such as octadecene, benzyl ether, phenyl ether, or combinations thereof can be used for operation 510. In some aspects, the Group 8-11 metal complex 209 is introduced to the mixture 409 as a solution/suspension in a solvent. For example, a nitrogen-containing compound, such as those described above, can be utilized as a solvent.

Operation 510 can include introduction conditions 412 and reaction conditions 414 of FIG. 4A. The introduction conditions 412 refer to the conditions at which the Group 8-11 metal complex 209 is introduced to the mixture 409 comprising the Group 10-11 metal complex 405, the phosphorous-containing compound 407, and optional solvent by, e.g., injection, addition, or otherwise combining the Group 8-11 metal complex 209 with the mixture 409. The reaction conditions 414 refer to the conditions at which the Group 8-11 metal complex 209 and one or more components of the mixture 409 are reacted. The introduction conditions 412 and reaction conditions 414 can be the same or different.

The introduction conditions 412 include an introduction temperature. The introduction temperature, or injection temperature, of operation 510 can be about 400° C. or less, such as from about 50° C. to about 400° C., such as from about 75° C. to about 375° C., such as from about 80° C. to about 340° C., such as from about 90° C. to about 330° C., such as from about 100° C. to about 320° C., such as from about 110° C. to about 310° C., such as from about 120° C. to about 300° C., such as from about 130° C. to about 290° C., such as from about 140° C. to about 280° C., such as from about 150° C. to about 270° C., such as from about 160° C. to about 260° C., such as from about 170° C. to about 250° C., such as from about 180° C. to about 240° C., such as from about 190° C. to about 230° C., such as from about 200° C. to about 220° C. In some aspects, the introduction temperature or injection temperature of operation 510 can be from about 80° C. to about 320° C., such as from about 80° C. to about 150° C. or from about 180° C. to about 320° C., such as from about 200° C. to about 300° C. Higher or lower introduction/injection temperatures can be used when appropriate.

The resultant mixture containing the Group 10-11 metal complex 405, the phosphorous-containing compound 407, the Group 8-11 metal complex 209, and the optional solvent, can be stirred, mixed or otherwise agitated at the introduction temperature for a time period of about 1 min or more or about 24 h or less, such as from about 1 min to about 12 h, such as from about 5 min to about 6 h, such as from about 10 min to about 3 h, such as from about 15 min to about 1 h. The introduction conditions 412 of operation 510 can optionally include introducing N₂, Ar, and/or other non-reactive gases prior to, during, and/or after, introducing the Group 8-11 metal complex 209 to the mixture 409.

After introduction of the Group 8-11 metal complex 209 to the mixture 409, one or more components of the resultant mixture react, under reaction conditions 414, to form the bimetallic structure 413. Here, the reaction conditions 414 of operation 510 can include heating the mixture containing the Group 10-11 metal complex 405, the phosphorous-containing compound 407, the Group 8-11 metal complex 209, and the optional solvent, at a reaction temperature of about 400° C. or less, such as from about 50° C. to about 400° C., such as from about 75° C. to about 375° C., such as from about 80° C. to about 340° C., such as from about 90° C. to about 330° C., such as from about 100° C. to about 320° C., such as from about 110° C. to about 310° C., such as from about 120° C. to about 300° C., such as from about 130° C. to about 290° C., such as from about 140° C. to about 280° C., such as from about 150° C. to about 270° C., such as from about 160° C. to about 260° C., such as from about 170° C. to about 250° C., such as from about 180° C. to about 240° C., such as from about 190° C. to about 230° C., such as from about 200° C. to about 220° C. In some aspects, the reaction temperature of reaction conditions 414 can be from about 80° C. to about 320° C., such as from about 80° C. to about 150° C. or from about 180° C. to about 320° C., such as from about 200° C. to about 300° C. Higher or lower temperatures can be used when appropriate. The reaction conditions 414 of operation 510 can include a time of about 1 min or more or about 24 or less, such as from about 1 min to about 12 h, such as from about 5 min to about 3 h, such as from about 10 min to about 1 h. Higher or lower temperatures and/or more or less periods of time can be used when appropriate. Stirring, mixing, and/or agitation can be performed to, e.g., ensure homogeneity. The reaction conditions 414 of operation 510 can include introducing N₂, Ar, and/or other non-reactive gases before, during, and/or after reaction of the one or more components.

In some examples, the reaction conditions 414 include an operating temperature that is higher than, less than, or equal to the operating temperature of the introduction conditions 412.

After a suitable time, the reaction product mixture comprising the bimetallic structure 413 formed during operation 510 can be subjected to filtration, separation, cleaning, quenching, washing, purification, and/or other suitable processes to remove undesired components and isolate the bimetallic structure 413 from the other components of the reaction product mixture. For example, the reaction product mixture comprising the bimetallic structure 413 can be centrifuged to separate the bimetallic structure 413 (which may be in the form of particles) from the reaction product mixture. Additionally, or alternatively, the bimetallic structure 413 can be washed with polar solvent(s), such as water, acetone, ethanol, methanol, or combinations thereof, and/or non-polar solvent(s), such as hexane, pentane, toluene, or combinations thereof. Other solvents for washing can include ether solvents such as diethyl ether and tetrahydrofuran; chlorocarbon solvents such as dichloromethane and chloroform; as well as ethyl acetate, dimethylformamide, acetonitrile, benzene, isopropanol, n-butanol, n-propanol. Mixtures of two or more of these solvents, in suitable proportions, can be utilized for washing, purifying, or otherwise separating the bimetallic structure 413 from other components in the reaction product mixture. As an example, a solvent or mixture of solvents can be added to the bimetallic structure 413 and the resultant mixture centrifuged. The supernatant can be discarded and the remaining pellet can be dispersed in a suitable solvent or mixture of solvents. The resultant pellet and solvent(s) can then be centrifuged to obtain the bimetallic structure 413.

As a non-limiting example of operation 510, an alkylphosphine with or without a nitrogen-containing compound, such as OLA, can be degassed using a non-reactive gas while agitating. The alkylphosphine with or without a nitrogen-containing compound can be heated to a temperature of about 275° C. to about 350° C. A copper amine is then added to the alkylphosphine and agitated. The resultant mixture (e.g., mixture 409) containing the copper amine and the alkylphosphine is then set to introduction conditions 412 such as an introduction temperature from about 100° C. to about 140° C., stirred for a suitable period of time, under suitable pressures, with or without the presence of a non-reactive gas. A Group 8-11 metal amine, with or without a nitrogen-containing compound, is then added to the mixture at this introduction temperature and stirred under the introduction conditions 412 for a suitable period of time, under suitable pressures, with or without the presence of a non-reactive gas. At a selected time point, the mixture of the Group 8-11 metal amine, alkylphosphine, and copper amine are placed under the reaction conditions 414. The reaction conditions 414 can be the same or different conditions as the introduction conditions 412. In this example, the reaction conditions 414 include heating the mixture of the Group 8-11 metal amine, alkylphosphine, copper amine, and optional nitrogen-containing compound(s) (as solvent(s)), at a temperature from about 225° C. to about 275° C. for a suitable period of time, under suitable pressures, and with or without the presence of a non-reactive gas, to form the bimetallic structure 413. The bimetallic structure 413 can then be subjected to filtration, separation, cleaning, quenching, washing, purification, and/or other suitable processes to remove undesired components and/or isolate the bimetallic structure 413 from the other components of the reaction mixture.

Process 500 further includes introducing a Pt-containing precursor (for example, a Pt metal complex 425) with the bimetallic structure 413 to form a trimetallic structure 418 at operation 520.

Reaction diagram 420 of FIG. 4B shows a general scheme for forming a Pt metal complex 425 from a platinum source and a nitrogen-containing compound 423. The nitrogen-containing compound 423 can be those described above for nitrogen-containing compound 202, though other nitrogen-containing compounds are contemplated. Conditions 422 to form the Pt metal complex 425, molar ratios of starting materials, and other parameters can be the same as those described above with reference to reaction diagram 220 (FIG. 2B) or reaction diagram 240 (FIG. 2C). Pt metal source 421 can include platinum halides, platinum acetates, platinum nitrates, and/or other suitable platinum species. Hydrates are also contemplated. Examples of Pt metal source 421 can include, but are not limited to, hexachloroplatinic acid (or hydrates thereof, for example, H₂PtCl₆·6H₂O), platinum chloride (PtCl₄), potassium platinum(II) chloride (K₂PtCl₄), platinum(II) acetate (Pt(CH₃CO₂)₂), platinum(IV) acetate (Pt(CH₃CO₂)₄), sodium hexachloroplatinate hexahydrate (Na₂PtCl₆·6H₂O), and platinum(II) acetylacetonate (Pt(C₅H₇O₂)₂)

Reaction conditions 416 effective to form the trimetallic structure 418 can include a reaction temperature and a reaction time. The reaction temperature of reaction conditions 416 can be from about 80° C. to about 340° C., such as from about 90° C. to about 330° C., such as from about 100° C. to about 320° C., such as from about 110° C. to about 310° C., such as from about 120° C. to about 300° C., such as from about 130° C. to about 290° C., such as from about 140° C. to about 280° C., such as from about 150° C. to about 270° C., such as from about 160° C. to about 260° C., such as from about 170° C. to about 250° C., such as from about 180° C. to about 240° C., such as from about 190° C. to about 230° C., such as from about 200° C. to about 220° C. In some aspects, the reaction temperature of reaction conditions 416 can be from about 80° C. to about 320° C., such as from about 80° C. to about 150° C. or from about 180° C. to about 320° C., such as from about 200° C. to about 300° C. Higher or lower temperatures can be used when appropriate. The reaction conditions 416 of operation 520 can include a of about 5 min or more or about 72 h or less, such as from about 30 min to about 48 h, such as from about 1 h to about 24 h. Higher or lower temperatures and/or more or less periods of time can be used when appropriate. Stirring, mixing, and/or agitation can be performed to, e.g., ensure homogeneity. The reaction conditions 416 of operation 520 can include introducing N₂, Ar, and/or other non-reactive gases before, during, and/or after reaction of the one or more components. Any reasonable pressure can be used during formation of the trimetallic structure 418.

In some aspects, the reaction product comprising the trimetallic structure 418 can be subjected to filtration, separation, cleaning, quenching, washing, purification, and/or other suitable processes to remove undesired components and isolate the trimetallic structure 418 from the other components of the reaction mixture. For example, the reaction product comprising the trimetallic structure 418 (which may be in the form of particles) can be centrifuged to separate the trimetallic structure 418 from the mixture. Additionally, or alternatively, the trimetallic structure 418 can be washed with polar solvent(s), such as water, acetone, ethanol, methanol, or combinations thereof, and/or non-polar solvent(s), such as hexane, pentane, toluene, or combinations thereof. Other solvents for washing can include ether solvents such as diethyl ether and tetrahydrofuran; chlorocarbon solvents such as dichloromethane and chloroform; as well as ethyl acetate, dimethylformamide, acetonitrile, benzene, isopropanol, n-butanol, n-propanol. Mixtures of two or more of these solvents, in suitable proportions, can be utilized for washing, purifying, or otherwise separating the trimetallic structure 418 from other components in the reaction mixture. As an example, a solvent or a mixture of solvents can be added to the trimetallic structure 418 and the resultant mixture centrifuged. The supernatant can be discarded and the remaining pellet can be dispersed in a suitable solvent or mixture of solvents. The resultant pellet and solvent(s) can then be centrifuged to obtain the trimetallic structure 418. In these and other aspects, the pellet comprising the trimetallic structure 418 can be re-solubilized or re-suspended in a suitable solvent such as water or those described above.

Process 500 further includes reacting, under reaction conditions 417, a mixture comprising the trimetallic structure 418, a carbon source 213, and an acid 215 to form a catalyst composition comprising a carbon-supported trimetallic nanoframe 419 at operation 530. The catalyst composition can be those described above. Operation 530 can convert the solid trimetallic structure to an at least partially hollow trimetallic structure (for example, a trimetallic nanoframe). Operation 530 can cause the trimetallic nanoframe to be chemically bonded to the carbon source, for example, chemically bonded to a surface of the carbon support. As described above, the carbon support can include carboxyl groups (—COOH) and/or ions thereof (—COO⁻) that can bond to one or more metals of the metallic structures.

The resulting carbon-supported trimetallic nanoframe 419 can have a higher concentration of Pt than the concentration of Pt in the trimetallic structure 418. For example, the carbon-supported trimetallic nanoframe 419 formed from operation 530 can have a higher molar ratio of Pt to a total amount of Group 8-11 and Group 10-11 metal (such as Ni and Cu) than the molar ratio of Pt to total amount of Group 8-11 and Group 10-11 metal of the trimetallic structure 418 formed at operation 520. While not wishing to be bound by any theory, it is believed that certain atoms in the trimetallic structure 418 can be oxidized and removed by use of the acid and hollow nanostructures (for example, trimetallic nanoframe) are formed due to the those atoms diffusing from the interior to the exterior.

Molar ratios and mass percents for the metals present in the trimetallic nanoframe portion of the carbon-supported catalyst are described above.

Operation 530 can be performed in the same or similar manner as that described above for operation 320. Examples of carbon sources (e.g., carbon source 213), acids (e.g., acid 215) are described with respect to operation 320. Reaction conditions 417, as well as other parameters such as amounts of materials, molar ratios, etc. can be the same as or similar as those described above for second conditions 217 well as parameters are described with respect to operation 320.

Characteristics of the carbon-supported trimetallic nanoframe 419 formed from operation 530 are described above.

The following examples are put forth so as to provide those of ordinary skill in the art with a complete disclosure and description of how to make and use aspects of the present disclosure, and are not intended to limit the scope of aspects of the present disclosure. Efforts have been made to ensure accuracy with respect to numbers used (such as the amounts, dimensions) but some experimental errors and deviations should be accounted for.

### EXAMPLES

Various example, but non-limiting, catalysts according to some aspects described herein were prepared. The example catalysts were compared to a commercial platinum on carbon (Pt/C) catalyst. The comparative Pt/C catalyst represents the state-of-the-art for fuel cells and is 20 wt % Pt loading on an activated carbon support (Vulcan XC-72R).

### Materials and Characterization Methods

Oleylamine (OLA, 70%), hexadecylamine (90%, HDA), octadecylamine (95%, ODA), nickel acetylacetonate (Ni(acac)₂), nickel nitrate (Ni(NO₃)₂), nickel chloride (NiCl₂), hexachloroplatinic acid hexahydrate (H₂PtCl₆·6H₂O), sodium hexachloroplatinate hexahydrate (Na₂PtCl₆·6H₂O), platinum chloride (PtCl₄), platinum acetylacetonate (Pt(C₅H₇O₂)₂), trioctylphosphine (TOP, 97%), toluene (99.9%), acetone (99%), chloroform (99.9%), 1-octadecene (ODE, 98%), acetic acid (CH₃COOH) perchloric acid (HClO₄), and nafion (5 wt %) were purchased from Sigma-Aldrich. Tetradecylamine (TDA, >96%) was purchased from TCI. Hexane (99%), methanol (99%), and ethanol (200 proof) were purchased from Fisher Chemicals. All chemicals were used as received.

The surface morphologies were investigated by a scanning electron microscope (SEM, QUANTA FEG 650) from FEI with a field emitter as electron source. A Bruker D8 Advance X-ray diffractometer with Cu Kα radiation operated at a tube voltage of 40 kV and a current of 40 mA was used to obtain X-ray diffraction (XRD) patterns. Transmission electron microscopy (TEM) images were captured using an FEI Tecnai 20 microscope with an accelerating voltage of 200 kV.

Inductively coupled plasma-mass spectrometry (ICP-MS) was used to measure metal contents in the samples. ICP-MS was performed using an inductively coupled mass spectrometer (Thermo Fisher Scientific iCAP™ RQ ICP-MS).

All electrochemical measurements were measured on an electrochemical workstation (BioLogic) at room temperature (25° C.), using a three electrode electrochemical setup with a rotating disk electrode (RDE) system. A glassy carbon working electrode (GCE, 5 mm inner diameter, 0.196 cm²), a graphite rod counter electrode and a 3.0 M KCl saturated Ag/AgCl reference electrode were used for all the tests. All potentials are provided with respect to a reversible hydrogen electrode (RHE). The cyclic voltammetry (CV) scans were performed at a rate of 50 mV s⁻¹ near the thermodynamic potential of the H⁺/H₂ reaction. The potential at the zero current point was chosen as the reaction potential of the hydrogen electrode. The potential at the zero current point was determined to be −0.287 V, so the potential measured with a Ag/AgCl electrode can be related by E (RHE)=E (Ag/AgCl)+0.287 V.

Before the electrochemical tests, samples were first loaded on a commercial carbon support (Vulcan XC-72R) to provide a dispersion. For comparison, a commercial platinum on carbon (Pt/C, 20 wt %, Sigma-Aldrich) was used as the baseline. The electrode was prepared as follows. First, a catalyst ink was prepared by ultrasonicating a mixture of about 4.0 mg commercial Pt/C catalyst sample, about 1.6 mL water, about 0.4 mL isopropanol, and about 20 μL Nafion™ solution (5 wt %) for about 30 min to form a catalyst ink. About 10 μL of the catalyst ink was then spread onto the GCE surface using a micropipette and dried under ambient conditions. The Pt loading for all the catalyst samples was kept at about 20 μg/cm², which was further determined by ICP-MS measurements.

Cyclic voltammetry (CV) characterization of the catalyst samples in the absence of oxygen was carried out in the potential range of 0.1-1.1 V (vs. RHE) at a scan rate of 50 mV s⁻¹ in a N₂-saturated 0.1 M HClO₄ solution. The oxygen reduction reaction (ORR) polarization curves were recorded in an O₂-saturated 0.1 M HClO₄ electrolyte solution at a rotation speed of 1600 rpm and a scan rate of 20 mV s⁻¹.

For the CV activation and ORR process of the example Pt—Ni/C catalysts, the ORR activity was conducted immediately after a thirty-cycle CV activation.

Mass activity and loss in mass activity is determined at 0.9 V with a reference to the reversible hydrogen electrode (V_{RHE}).

Surface active area of the Pt—Ni/C catalysts is determined by cyclic voltammetry (CV) measurements. CV measurements were carried out in 0.1 M HClO4 solutions under a flow of N₂ or Ar (Airgas, ultrahigh purity) at a sweep rate of 50 mV/s. The ECSA was estimated by measuring the charge associated with Hupd adsorption (QH) between 0 and 0.37 V and assuming 210 μC/cm² for the adsorption of a monolayer of hydrogen on a Pt surface (qH). The Hupd adsorption charge (QH) can be determined using QH=0.5×Q, where Q is the charge in the Hupd adsorption/desorption area obtained after double-layer correction. Then, the specific ECSA was calculated based on the following relation:

specific ECSA=Q_{H}/m·q_{H}

where Q_{H} is the charge for Hupd adsorption, m is the loading amount of metal, and q_{H} is the charge required for monolayer adsorption of hydrogen on a Pt surface.

### Example 1: Synthesis of Example Metal Amines

### Ex. 1A. Synthesis of Nickel-OLA (Ni-OLA) Precursor Stock Solution

Ni(acac)₂ (128 mg, 0.5 mmol) and OLA (4 mL) were mixed in a flask under an Ar or N₂ environment to form a solution/suspension. The solution/suspension was then heated at 50-150° C. and shaken for 5 minutes. The solution/suspension was then cooled to room temperature. This Ni-OLA solution/suspension was utilized as a Ni-OLA precursor stock solution.

Various parameters were also investigated. Similar precursor stock solutions were investigated and can be prepared using other nickel materials such as, for example, nickel nitrate, nickel chloride, among other nickel salts. Various other amines were investigated and can utilized such as TDA, HDA, ODA, among other amines. Larger or smaller amounts of the materials were investigated. For example, amounts of nickel materials were investigated and can vary from, at least, the range of 0.062 mmol to 5 mmol with the amounts of amine (for example, OLA or others) varied accordingly.

### Ex. 1B. Synthesis of Platinum-OLA (Pt-OLA) Precursor Stock Solution

H₂PtCl₆·6H₂O (0.1 mmol, 51.7 mg) and OLA (3 mL) were mixed in a flask under an Ar or N₂ environment to form a solution/suspension. The solution/suspension was then heated at 50-150° C. and shaken for 5 minutes. The solution/suspension was then cooled to room temperature. This Pt-OLA solution/suspension was utilized as a Pt-OLA precursor stock solution.

Various parameters were also investigated. Similar precursor stock solutions were investigated and can be prepared using other platinum materials as well as other amines such as, for example, TDA, HDA, ODA, among other amines. Larger or smaller amounts were investigated. For example, amounts of platinum materials were investigated and can vary from, at least, the range of 0.05 mmol to 5 mmol with the amounts of amine (for example, OLA or others) varied accordingly.

### Ex. 1C. Synthesis of Copper-TDA (Cu-TDA)

Copper (I) chloride (100 mg, 1 mmol), TDA (240 mg), and ODE (2 mL) were mixed in a flask under an Ar or N₂ environment to form a solution/suspension. After degassing for 20 minutes, the solution/suspension was heated to 200° C. under Ar and/or N₂. After keeping the solution/suspension at this temperature for 10 minutes, the solution/suspension was cooled to room temperature. This Cu-TDA solution/suspension was utilized as a Cu-TDA precursor stock solution.

Various parameters were also investigated. Similar precursor stock solutions were investigated and can be prepared using other copper materials such as copper acetate or copper nitrate, among other copper materials, as well as other amines such as, for example, OLA, HDA, ODA, among other amines. Larger or smaller amounts were investigated. For example, amounts of copper materials were investigated and can vary from, at least, the range of 0.05 mmol to 10 mmol with the amounts of amine (for example, TDA or others) varied accordingly.

### Example 2: Synthesis of Example Polyhedral Nanoparticles

### Ex. 2A. Synthesis of Platinum-Nickel (Pt—Ni) Polyhedral Nanoparticles (NPs)

H₂PtCl₆·6H₂O (0.1 mmol, 51.7 mg) and HDA (40 mmol, 10.0 g) were loaded into a 50 mL three-neck flask equipped with a magnetic stir bar to form a reaction mixture. Argon gas was flown into the flask for 20 min to remove O₂ from the system. The reaction mixture was heated to 200° C. with stirring, the reaction mixture quickly turned light gray, and Ni-OLA precursor stock solution (3 mL) was injected into the reaction mixture. After 20 min at 200° C. with stirring, the reaction mixture was cooled to 80° C. At this point, about 5 mL of hexane (or another hydrophobic solvent such as toluene and/or chloroform) and 5 mL of ethanol were added and the mixture was centrifuged at 3,000 rpm for 2 min to remove excess reactants and excess amine. The supernatant was discarded. Hexane (10 mL) was then added to the sediment, and the mixture was centrifuged at 4,000 rpm for 5 min. The washing procedure was repeated twice to remove unreacted precursors and excess amine. The Pt—Ni polyhedral NPs were stored in a hydrophobic solvent (for example, hexane, toluene, and/or chloroform) before further use and/or characterization.

The Pt—Ni polyhedral NPs had the following formula: Pt₆₀Ni₄₀. Other non-limiting Pt—Ni polyhedral NPs were made and had the following formulas: Pt₇₅Ni₂₅; Pt₅₅Ni₄₅; Pt₅₀Ni₅₀; Pt₄₀Ni₆₀; Pt₆₆Ni₃₃; and Pt₂₅Ni₇₅.

Various parameters were also investigated. Various temperatures at which the injection of the Ni-OLA precursor were tested and can vary from at least about 80° C. to about 250° C. Other platinum materials as well as other amines were investigated, such as, for example, TDA, ODA, OLA, among other amines, and can be utilized. Larger or smaller amounts were investigated. For example, amounts of platinum materials were investigated and can vary from, at least, the range of 0.04 mmol to 1.3 mmol with the amounts of amine (for example, OLA or others) varied accordingly.

### Ex. 2B. Synthesis of Copper Nickel (Cu—Ni) Polyhedral Nanoparticles (NPs)

OLA (70%, 6 mL) was added to a 50 mL three-neck flask and the flask was fixed to a vertical gas flow column. Oxygen was removed by Ar or N₂ blowing for 20 min. After degassing, TOP (1 mL) was injected into the three-neck flask under an Ar or N₂ environment. After degassing for 20 minutes, the mixture was rapidly heated to about 300° C. under Ar and/or N₂. Next, Cu-TDA precursor stock solution (0.5 mol/L, 2 mL) as injected into the three-neck flask, and the reaction solution was mixed until a bright red color was observed. The reaction solution was then cooled to a temperature of 120° C. and then 4 mL of the Ni-OLA stock solution (Ex. 1B) was injected, and the reaction solution was maintained at 120° C. After about 1 hour at 120° C., the reaction solution was heated to 250° C. After about 3 minutes at 250° C., the heating mantle was turned off and the reaction solution was cooled to room temperature. Hexane (5 mL (or other hydrophobic solvent such as toluene and chloroform) and ethanol (5 mL) were added into the three-neck flask. The resulting Cu—Ni polyhedral nanoparticles were isolated by centrifuging at 4000 rpm for 5 minutes, and the supernatant was discarded. Another amount of hexane (about 10 mL) and ethanol (10 mL) were then added to the pellet and the mixture was centrifuged at about 4000 rpm for 5 minutes. The Cu—Ni polyhedral NPs were stored in a hydrophobic solvent (e.g., hexane, toluene, and/or chloroform) before further use and/or characterization.

The Cu—Ni polyhedral NPs had the following formula: Cu₈₀Ni₂₀. Other non-limiting Cu—Ni polyhedral NPs were made and had the following formulas: Cu₆₀Ni₄₀; Cu₅₀Ni₅₀; Cu₄₀Ni₆₀; Cu₁₀Ni₉₀.

Various parameters were also investigated. For example, the temperature at which the Ni precursor was injected can range from, at least, 200° C. to 300° C. After the injections, the reaction solution can be stirred at a temperature from, at least, 100° C. to 220° C. for an hour. The temperature can then be heated at 250° C. Different Ni stock solution were also investigated. For example, Ni-OLA stock solutions can be made from nickel nitrate or nickel chloride. Tributylphosphine (TBP) was also investigated and can be used instead of TOP.

### Ex. 2C. Synthesis of Pt—Cu—Ni Polyhedral Nanoparticles (NPs)

Cu—Ni polyhedral NPs (about 30-50 mg), made according to Ex. 2B, were dried using an inert gas (for example, argon or N₂) and transferred to a 50 mL three-neck flask and the flask was fixed to a vertical gas flow column. Oxygen was removed by Ar or N₂ blowing for 20 min. ODE (6 mL) and OLA (3 mL) were added. Pt-OLA precursor stock solution (0.06 mmol/L, 3 mL) was injected to the reaction mixture at 80° C. and the reaction temperature was raised to a reaction temperature of 200° C. After 1 hour of reaction time at 200° C., the reaction was stopped and the reaction solution was cooled to room temperature. Hexane (5 mL (or other hydrophobic solvent such as toluene and chloroform) and ethanol (5 mL) were added into the three-neck flask. The resulting Cu—Ni polyhedral nanoparticles were isolated by centrifuging at 4000 rpm for 5 minutes, and the supernatant was discarded. Another amount of hexane (about 10 mL) and ethanol (10 mL) were then added to the pellet and the mixture was centrifuged at about 4000 rpm for 5 minutes. The Pt—Cu—Ni polyhedral NPs were stored in a hydrophobic solvent (e.g., hexane, toluene, and/or chloroform) before further use and/or characterization.

The Pt—Cu—Ni polyhedral NPs had the following formula: Pt₆₅Cu₁₅Ni₂₀. Other non-limiting Pt—Cu—Ni polyhedral NPs were made and had the following formulas: Pt₅₈Cu₁₅Ni₂₅; Pt₅₁Cu₂₂Ni₂₇; Pt₄₅Cu₂₅Ni₃₀; Pt₃₅Cu₃₆Ni₂₉.

Various parameters were also investigated. For example, various concentrations of the Pt precursor stock solution were tested and can be varied in the range of, at least, 0.01 mmol to 10 mmol/L. Different reaction times were tested and can vary from, at least, 5 minutes to 72 hours. Different reaction temperatures were tested and can vary from, at least, 80° C. to 300° C. Different volumes of ODE were tested and can vary from, at least, 0.5 mL to 1 L. Different volumes of OLA were tested and can vary from, at least, 0.5 mL to 1 L. Amounts of Cu—Ni polyhedral NPs were tested and can be varied from, at least, 1 mg to 1 kg.

### Example 3: Forming Example Hollow Nanocatalysts on Carbon

### Ex. 3A. Synthesis of Pt—Ni Hollow Nanocatalysts on Carbon

10 mg of the Pt—Ni hydrophobic polyhedral NPs (also called nanocatalysts), made according to Ex. 2A, were dispersed in hexane (5 mL) and sonicated for 10 min. Vulcan XC-72 carbon (15 mg) was dispersed in hexane (5 mL) and sonicated for 10 min. The Pt—Ni hydrophobic polyhedral nanoparticles dispersion and the Vulcan XC-72 carbon dispersion were mixed and sonicated for 2 hours. The resultant mixture was heated to remove hexane under an argon gas was flow. Acetic acid (4 mL) was added to mixture and allowed to soak in the mixture for 16 hours at room temperature. At this point, the products were separated by centrifuging at 3,000 rpm for 2 min. Deionized (DI) water (10 mL) was then added to the sediment, and the mixture was centrifuged at 4,000 rpm for 5 min. The washing procedure was repeated twice to remove unreacted precursors and surfactant (for example, amines, acids, phosphines, etc.). The Pt—Ni/C products were stored in a hydrophilic solvent (for example, water, ethanol, and/or isopropanol) before further use and/or characterization. The Pt—Ni/C products were characterized to be Pt—Ni/C hydrophilic hollow nanocatalysts.

Various parameters were investigated. For example, various weight ratios of catalysts to carbon support were investigated and can vary from, at least, 5:1 to 1:10. Different amounts of Pt—Ni hydrophobic polyhedral nanoparticles (nanocatalysts) were tested and can vary from, at least, 1 mg to 1 kg. Various acid soaking times were investigated can vary from, at least, 1 hour to 72 hours. Different acid soaking temperatures were tested and can vary from, at least, room temperature to 100° C. Acids besides acetic acid were also investigated. For example, sulfuric acid, perchloric acid, phosphoric acid, among others were tested and can be utilized.

This synthetic strategy was also investigated to form other Pt-based bimetallic hollow nanocatalysts on carbon, for example, Pt—Co/C, Pt—Cu/C, Pt—Pd/C, and Pt—Ag/C, where the molar ratio of Pt to other metal (e.g., Co, Cu, etc.) were 75:25, 55:45; 50:50, 40:60, 66:33, and 25:75.

### Ex. 3B. Synthesis of Pt—Ni—Cu Hollow Nanocatalysts on Carbon

10 mg of the Pt—Ni—Cu hydrophobic polyhedral NPs (also called nanocatalysts), made according to Ex. 2C, were dispersed in hexane (5 mL) and sonicated for 10 min. Vulcan XC-72 carbon (15 mg) was dispersed in hexane (5 mL) and sonicated for 10 min. The Pt—Ni hydrophobic polyhedral nanoparticles dispersion and the Vulcan XC-72 carbon dispersion were mixed and sonicated for 2 hours. The resultant mixture was heated to remove hexane under an argon gas was flow. Acetic acid (4 mL) was added to mixture and allowed to soak in the mixture for 16 hours at room temperature. At this point, the products were separated by centrifuging at 3,000 rpm for 2 min. Deionized (DI) water (10 mL) was then added to the sediment, and the mixture was centrifuged at 4,000 rpm for 5 min. The washing procedure was repeated twice to remove unreacted precursors and surfactant (for example, amines, acids, phosphines, etc.). The Pt—Ni—Cu/C products were stored in a hydrophilic solvent (for example, water, ethanol, and/or isopropanol) before further use and/or characterization. The Pt—Ni—Cu/C products were characterized to be Pt—Ni—Cu/C hydrophilic hollow nanocatalysts.

Various parameters were investigated. For example, various weight ratios of catalysts to carbon support were investigated and can vary from, at least, 5:1 to 1:10. Amounts of Pt—Ni—Cu hydrophobic polyhedral NPs (nanocatalysts) were also tested and can vary from, at least, 1 mg to 1 kg. Various acid soaking times were investigated can vary from, at least, 1 hour to 72 hours. Different acid soaking temperatures were tested and can vary from, at least, room temperature to 100° C. Acids besides acetic acid were also investigated. For example, sulfuric acid, perchloric acid, phosphoric acid, among others were tested and can be utilized.

### Example 4: Non-Limiting Results and Discussion

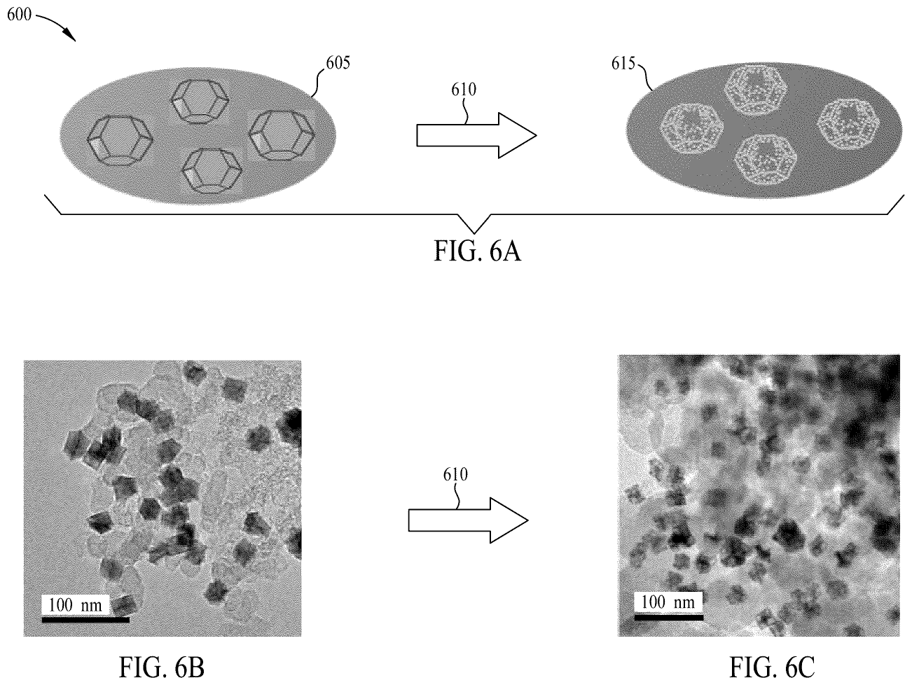

FIG. 6A shows a general reaction scheme 600 for the formation of Pt-based hydrophobic hollow nanocatalysts supported on carbon. The hydrophobicity can be due to the metal(s) being capped with hydrophobic ligands such as amines and phosphines (for example, oleylamine, hexadecylamine, trioctylphosphine, and so forth). Here, the Pt-based solid nanocatalysts 605 are mixed with a carbon source and subjected to acid treatment at operation 610 to form the Pt-based/C hollow nanoframes 615. In the reaction, the one or more group 8-11 metals that is not Pt can be oxidized and removed during the acid-treatment operation. The acid-treatment operation can improve the durability of catalysts due to the chemical bonding between the catalyst and the carbon surface. FIG. 6B shows a TEM image of Pt—Ni dodecahedron nanoparticles (corresponding to Pt-based solid nanocatalysts 605) and FIG. 6C shows a TEM image of Pt—Ni nanoframes on carbon supports (corresponding to Pt-based/C hollow nanoframes 615).

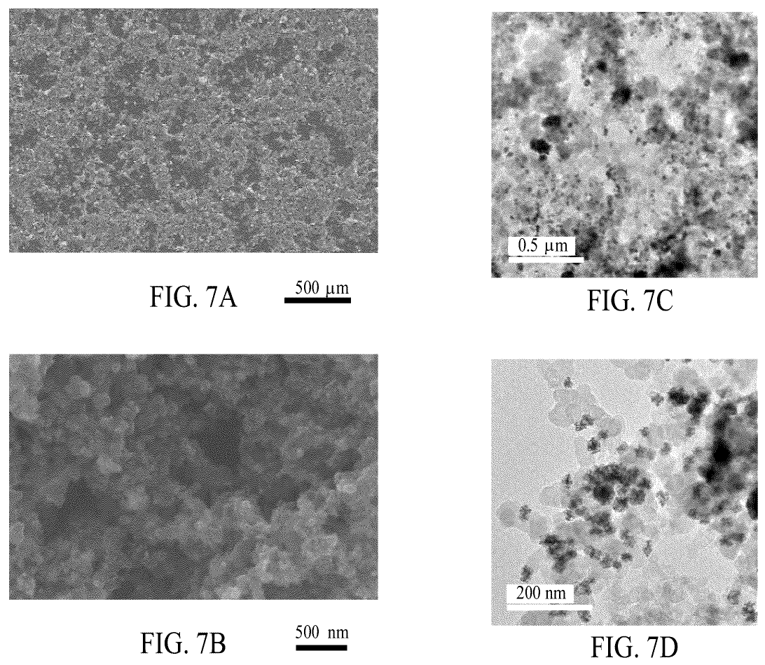

FIGS. 7A-7D show typical SEM images (FIGS. 7A and 7B) and TEM images (FIGS. 7C and 7D) of Pt—Ni hollow nanoframes/C formed from a 2:3 weight ratio of catalyst to carbon and acetic acid treatment. The Pt—Ni hollow nanoframes of the carbon-supported catalyst included about 60 mass % Pt and about 40 mass % Ni (molar ratio: Pt₁Ni₂, mass ratio: Pt₆₀Ni₄₀). The SEM and TEM images indicate a high density of Pt—Ni nanoframes being immobilized on the surface of the carbon supports. The nanoframes are shown by, for example, the contrast between the hollow center (light portion) and solid sides/edges (dark portion) in FIG. 7D.

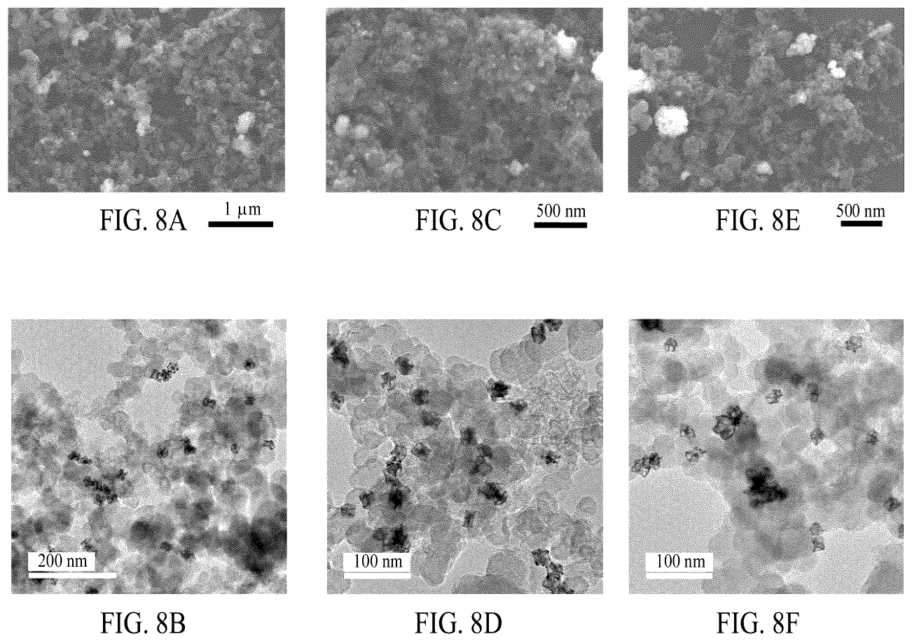

Various carbon-supported Pt—Ni hollow nanostructures were synthesized by changing the weight ratios of catalyst to carbon source and using various acids. SEM and TEM images of the resulting carbon-supported Pt—Ni hollow nanostructures (Pt—Ni nanoframes/C) are shown in FIGS. 8A-8F. Specifically, FIGS. 8A and 8B show SEM and TEM images, respectively, of Pt—Ni nanoframes/C formed from a ˜1:1 weight ratio of catalyst to carbon source and acetic acid treatment. FIGS. 8C and 8D show SEM and TEM images, respectively, of Pt—Ni nanoframes/C formed from a 2:1 weight ratio of catalyst to carbon source and acetic acid treatment. FIGS. 8E and 8F show SEM and TEM images, respectively, of Pt—Ni nanoframes/C formed from a ˜1:1 weight ratio of catalyst to carbon source and sulfuric acid treatment. The Pt—Ni hollow nanoframes of the carbon-supported catalyst shown in FIGS. 8A-8F included about 60 mass % Pt and about 40 mass % Ni (molar ratio: Pt₁Ni₂, mass ratio: Pt₆₀Ni₄₀).

The results indicate that, for example, various amounts of catalyst can be supported on the carbon, and that various acids can be utilized for acid treatment. The SEM and TEM images also reveal that more hollow Pt—Ni/C nanocatalysts can be formed via sulfuric acid treatment. Here, controlling the acid treatment period, the amount of acid, the type of acid, or combinations thereof can be utilized to adjust the hollowness of Pt-based nanocatalysts.

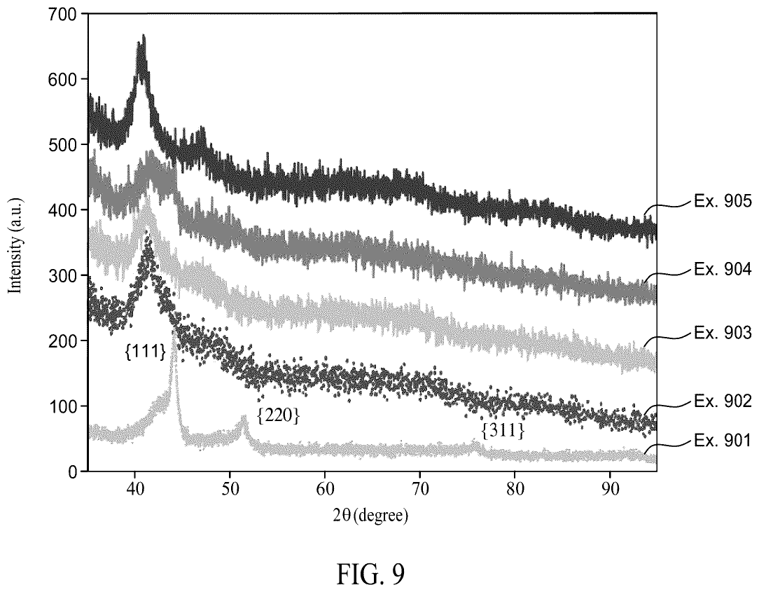

XRD patterns of example Pt—Ni nanoframes/C formed with different acids and different weight ratios of catalyst to carbon source are shown in FIG. 9. Examples 902-904 were made using an acetic acid treatment and Ex. 905 was made using a sulfuric acid treatment. The weight ratios of catalyst to carbon source included the following: about 2:3 (Ex. 902), about 1:1 (Ex. 903), about 2:1 (Ex. 904), and about 1:1 (Ex. 905). Ex. 901 shows the XRD pattern of an example Pt—Ni catalyst before acid treatment. The XRD pattern (Ex. 901) includes {111}, {200}, {220}, and {311} diffraction peaks which is consistent with a face centered cubic structure. After an acid treatment (Examples 902-905), the {111} diffraction peak shifted from a 20 of about 44.3° to about 40.5°. This result indicated that the Ni-rich Pt—Ni nanocatalyst (Ex. 901) was transformed into a Pt-rich Pt—Ni hollow nanocatalyst (Examples 902-905) by treatment with acid. Here, while not wishing to be bound by any theory, it is believed that nickel atoms can be oxidized and removed and subsequently hollow nanostructures are formed due to the nickel atoms diffusing from the interior to the exterior.

Table 1 shows the mass % and molar ratio of Pt and Ni in each of Examples 901-905.

TABLE 1

| | Pt, | Ni, | Molar ratio |
|---|---|---|---|
| Example | mass % | mass % | of Pt:Ni |
| 901 | 52 | 48 | Pt₂₅Ni₇₅ |
| 902 | 75 | 25 | Pt₅₀Ni₅₀ |
| 903 | 78 | 22 | Pt₅₅Ni₄₅ |
| 904 | 67 | 33 | Pt₄₀Ni₆₀ |
| 905 | 86 | 14 | Pt₆₆Ni₃₃ |

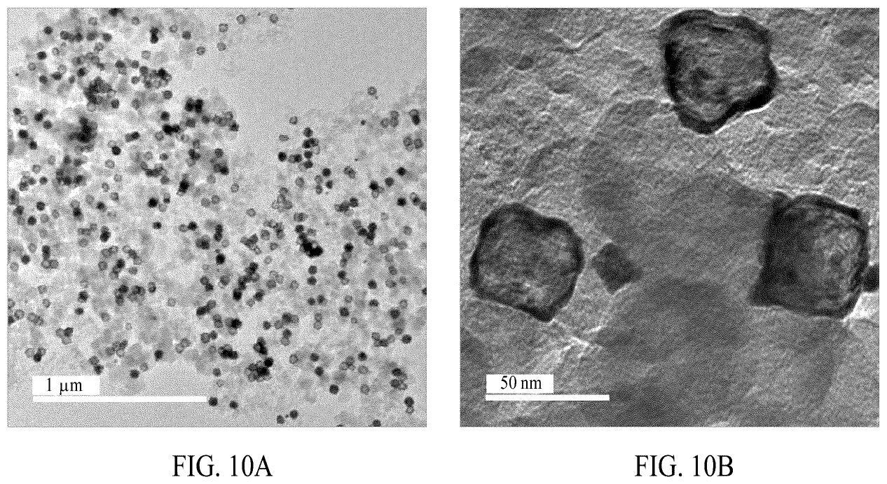

FIGS. 10A and 10B show TEM images of example Pt—Ni—Cu nanoframes on carbon supports (Pt—Ni—Cu nanoframes/C). The example Pt—Ni—Cu nanoframes/C were formed using a ˜2:3 weight ratio of catalyst to carbon source, with a sulfuric acid treatment of about 18 hours. The TEM images indicate a high density of Pt—Ni—Cu nanoframes being immobilized on the surface of the carbon supports. The nanoframes are shown by, for example, the contrast between the hollow center (light portion) and solid sides/edges (dark portion) in FIGS. 10A and 10B. The Pt—Ni—Cu nanoframes of the carbon-supported catalyst shown in FIGS. 10A and 10B comprised about 51 mass % Pt, about 23 mass % Ni, and about 26 mass % Cu (molar ratio: Pt₃₉Ni₂₇Cu₃₄; mass ratio: Pt₅₁Ni₂₃Cu₂₆).

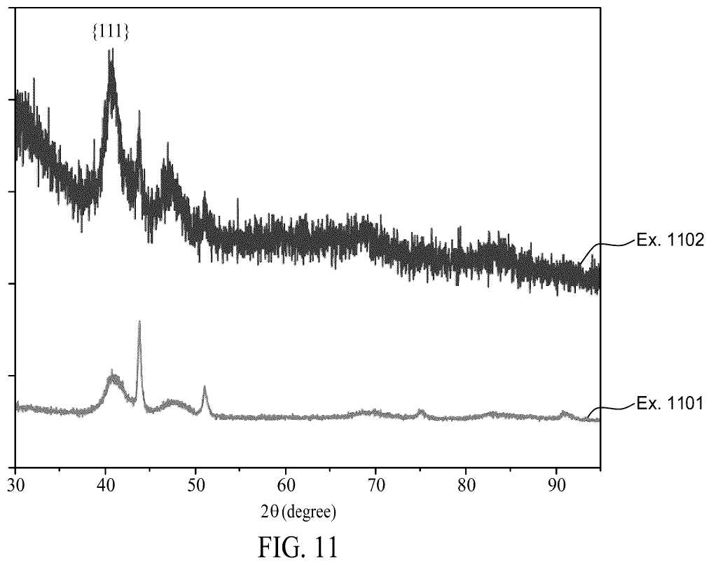

FIG. 11 shows an XRD pattern of example Pt—Ni—Cu nanoframes/C formed using a ˜2:3 weight ratio of catalyst to carbon source, with a sulfuric acid treatment of about 18 hours (Ex. 1102). Ex. 1101 shows the XRD pattern of an example Pt—Ni—Cu catalyst before acid treatment. When comparing the XRD patterns of Ex. 1101 to Ex. 1102, there is a clear shift of the {111} diffraction peak to a lower 20 value. This result indicates that hollow nanostructures were formed.

Table 2 shows the mass % and molar ratio of Pt, Ni, and Cu in each of Examples 1101 and 1102.

TABLE 2

| | Pt, | Ni, | Cu, | Molar ratio |
|---|---|---|---|---|
| Example | mass % | mass % | mass % | of Pt:Ni:Cu |
| 1101 | 46 | 24 | 30 | Pt₂₂Ni₃₅Cu₄₃ |
| 1102 | 51 | 23 | 26 | Pt₃₉Ni₂₇Cu₃₄ |

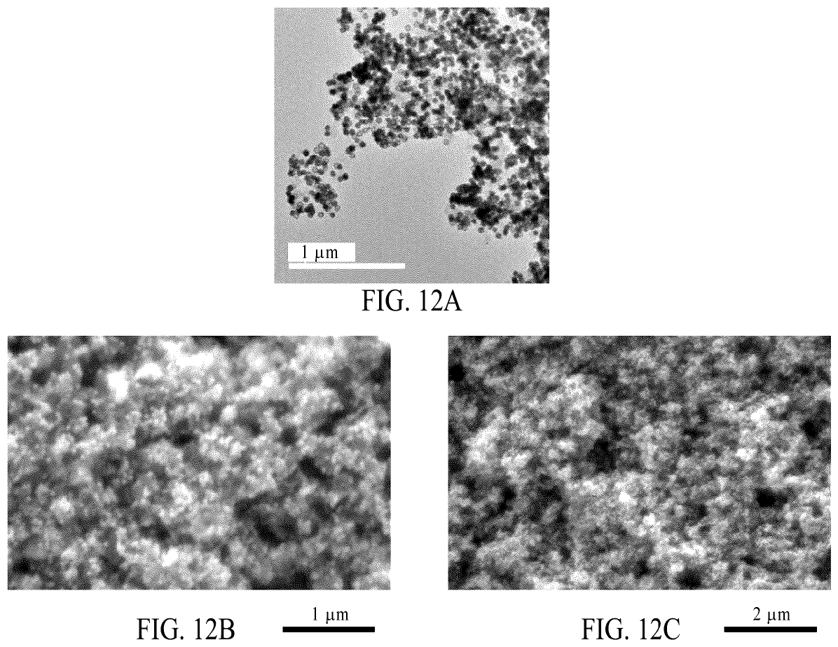

Example Pt—Ni—Cu nanoframes/C were also formed using a ˜2:1 weight ratio of catalyst to carbon source with sulfuric acid treatment. FIG. 12A shows a TEM image and FIGS. 12B and 12C show SEM images of the example Pt—Ni—Cu nanoframes/C. The TEM and SEM images indicate a high density of Pt—Ni—Cu nanoframes being immobilized on the surface of the carbon supports. The nanoframes are shown by, for example, the contrast between the hollow center (light portion) and solid sides/edges (dark portion). The Pt—Ni—Cu nanoframes of the carbon-supported catalyst shown in FIGS. 12A-12C comprised about 51 mass % Pt, about 23 mass % Ni, and about 26 mass % Cu (molar ratio: Pt₃₉Ni₂₇Cu₃₄; Mass ratio: Pt₅₁Ni₂₃Cu₂₆).

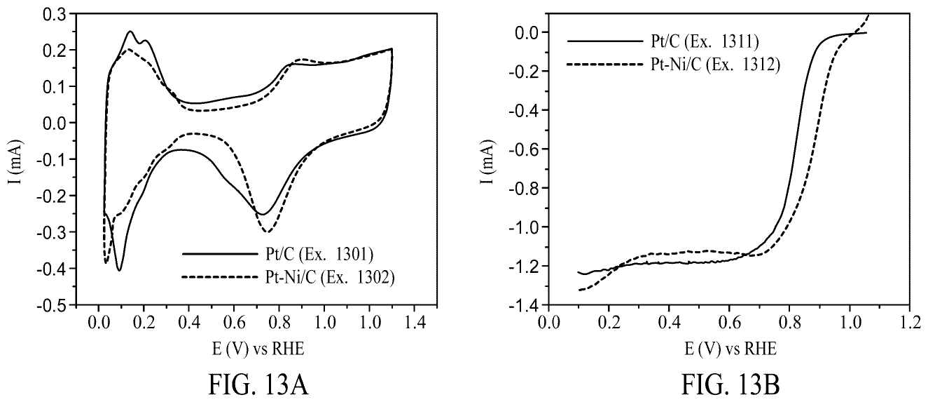

Electrocatalytic properties of example Pt—Ni/C hollow nanocatalysts were also investigated and compared to commercial Pt/C nanoscale electrocatalysts. Results are shown in FIGS. 13A and 13B. Specifically, FIG. 13A shows cyclic voltammetry curves of an example Pt—Ni/C hollow nanocatalyst (Ex. 1302) and a comparative Pt/C catalyst (Ex. 1301). FIG. 13B shows linear sweeping voltammetry curves of an example Pt—Ni/C hollow nanocatalyst (Ex. 1312) and a comparative Pt/C catalyst (Ex. 1311).

The supported catalysts formed by aspects described herein showed significantly improved performance over the comparative Pt/C catalyst. For example, the surface active area of an example Pt—Ni/C hollow nanocatalyst was determined to be about 194 m²/mg (Pt), which is twice that of the commercial Pt/C catalyst is 98 m²/mg (Pt). In addition, mass activities were also compared. Here, while the commercial Pt/C catalyst has a mass activity of 0.03 A/mg (Pt), an example Pt—Ni/C hollow nanocatalyst was determined to have a mass activity of about 0.69 A/mg (Pt). This data represents a significant improvement in catalytic performance (about 23 times higher mass activity). In addition, the mass activity of the example Pt—Ni/C hollow nanocatalyst exceeded the Department of Energy (DOE) requirement for further membrane electrode assembly tests (proton exchange membrane fuel cells, PEMFCs). The technical target set by the DOE is a mass activity of 0.44 A/mg (Pt) at 0.9 V for application of PEMFCs, clearly surpassed by the example Pt—Ni/C hollow nanocatalyst

Aspects of the present disclosure generally relate to processes for forming carbon-supported hollow nanocatalysts. Aspects described herein can enable the controlled synthesis of Pt-based hollow nanocatalysts on carbon supports via wet-chemistry methods. The Pt-based hollow nanocatalysts can include Pt and one or more Group 8-11 metals different from Pt. Overall, the carbon-supported Pt-based hollow nanocatalysts demonstrated significantly improved ORR performance in terms of at least mass activities and efficiency. Aspects described herein enable a low cost process for synthesizing carbon-supported Pt-based hollow nanocatalysts that has high value for commercial applications such as hydrogen fuel cell vehicles among other applications.

### Aspects Listing

The present disclosure provides, among others, the following aspects, each of which can be considered as optionally including any alternate aspects:

Clause A1. A process for forming a carbon-supported nanoframe, the process comprising:
forming a bimetallic structure by reacting a first precursor comprising platinum (Pt) and a second precursor comprising a Group 8-11 metal at a temperature of about 80° C. to about 300° C., wherein the Group 8-11 metal is free of Pt; and
forming a carbon-supported bimetallic nanoframe by reacting a mixture comprising the bimetallic structure, a carbon source, and an acid, wherein:
   the carbon-supported bimetallic nanoframe comprises a bimetallic nanoframe chemically bonded to a carbon support; and
   the bimetallic nanoframe has a higher molar ratio of Pt to Group 8-11 metal than a molar ratio of Pt to Group 8-11 metal of the bimetallic structure.

Clause A2. The process of Clause A1, wherein a weight ratio of the bimetallic structure to the carbon source used to form the carbon-supported bimetallic nanoframe is from about 5:1 to about 1:10.

Clause A3. The process of Clause A1 or Clause A2, wherein:
the acid is an inorganic acid; and
the mixture comprising the bimetallic structure, the carbon source, and the acid are reacted at a temperature of about 10° C. to about 100° C.

Clause A4. The process of any one of Clauses A1-A3, wherein the acid comprises acetic acid, sulfuric acid, phosphoric acid, perchloric acid, or combinations thereof.

Clause A5. The process of any one of Clauses A1-A4, wherein the Group 8-11 metal comprises Fe, Ru, Os, Co, Rh, Ir, Ni, Pd, Cu, Ag, Au, or combinations thereof.

Clause A6. The process of any one of Clauses A1-A5, wherein the bimetallic nanoframe comprises:
an interior that is at least partially hollow; and
a plurality of facets encapsulating the interior, each facet of the plurality of facets comprising metal atoms.

Clause A7. The process of Clause A6, wherein about 70% or more of the metal atoms are Pt.

Clause A8. The process of Clause A6, wherein about 85% or more of the metal atoms are Pt.

Clause A9. The process of any one of Clauses A1-A8, wherein the bimetallic nanoframe, when supported on carbon, has a mass activity of greater than 0.23 A/mg (Pt) at 0.9 V with a reference to a reversible hydrogen electrode (V_{RHE}).

Clause B1. A process for forming a carbon-supported nanoframe, the process comprising:
introducing a first metal precursor comprising a Group 8-11 metal with a mixture comprising a phosphorous-containing compound and a second metal precursor comprising a Group 10-11 metal to form a bimetallic structure, the Group 8-11 metal and the Group 10-11 metal being different, the Group 8-11 metal and the Group 10-11 metal being free of platinum;
introducing a platinum-containing precursor with the bimetallic structure to form a trimetallic structure; and
forming a carbon-supported trimetallic nanoframe by reacting a mixture comprising the trimetallic structure, a carbon source, and an acid, wherein:
   the carbon-supported trimetallic nanoframe comprises a trimetallic nanoframe chemically bonded to a carbon support; and
   the trimetallic nanoframe has a higher molar ratio of Pt to total amount of Group 8-11 and Group 10-11 metal than a molar ratio of Pt to a total amount of Group 8-11 and Group 10-11 metal of the trimetallic structure.

Clause B2. The process of Clause B1, wherein a weight ratio of the trimetallic structure to the carbon source used to form the carbon-supported trimetallic nanoframe is from about 5:1 to about 1:10.

Clause B3. The process of Clause B1 or Clause B2, wherein:
the acid is an inorganic acid; and
the mixture comprising the trimetallic structure, the carbon source, and the acid are reacted at a temperature of about 10° C. to about 100° C.

Clause B4. The process of any one of Clauses B1-B3, wherein the acid comprises acetic acid, sulfuric acid, phosphoric acid, perchloric acid, or combinations thereof.

Clause B5. The process of any one of Clauses B1-B4, wherein:
the Group 8-11 metal comprises Fe, Ru, Os, Co, Rh, Ir, Ni, Pd, Cu, Ag, Au, or combinations thereof; and
the Group 10-11 metal comprises Ni, Pd, Cu, Ag, Au, or combinations thereof.

Clause B6. The process of any one of Clauses B1-B5, wherein the trimetallic nanoframe comprises:
an interior that is at least partially hollow; and
a plurality of facets encapsulating the interior, each facet of the plurality of facets comprising metal atoms.

Clause B7. The process of Clause B6, wherein about 70% or more of the metal atoms are Pt.

Clause C1. A process for converting a solid catalyst to a conversion product, the process comprising:
exposing a solid metal catalyst and a carbon source to an acid to form an at least partially hollow metal catalyst chemically bonded to a carbon support, wherein:
   each of the solid metal catalyst and the at least partially hollow metal catalyst comprises Pt and at least one Group 8-11 metal of the periodic table of the elements;
   the at least one Group 8-11 metal is free of Pt; and
   a molar ratio of Pt to the at least one Group 8-11 metal of the at least partially hollow metal catalyst is higher than a molar ratio of Pt to the at least one Group 8-11 metal of the solid metal catalyst.

Clause C2. The process of Clause C1, wherein a weight ratio of the solid metal catalyst to the carbon source used to form the at least partially hollow metal catalyst chemically bonded the carbon support is from about 5:1 to about 1:10.

Clause C3. The process of Clause C1 or Clause C2, wherein the carbon source comprises a material selected from the group consisting of carbon black, carbon nanotube, carbon nanofiber, mesoporous carbon, carbon nanowire, acetylene black, graphite, graphene, graphene oxide, fullerene, and combinations thereof.

Clause C4. The process of any one of Clauses C1-C3, wherein the at least one Group 8-11 metal is selected from the group consisting of Fe, Ru, Os, Co, Rh, Ir, Ni, Pd, Cu, Ag, Au, and combinations thereof.

Clause D1. A process for forming a carbon-supported nanoframe, the process comprising:
forming a bimetallic structure by reacting a first precursor and a second precursor at a temperature of about 80° C. to about 300° C., the first precursor comprising a metal (M¹), the second precursor comprising a Group 8-11 metal (M²), wherein M¹ is platinum (Pt), wherein M² is free of Pt; and
forming a carbon-supported bimetallic nanoframe by reacting a mixture comprising the bimetallic structure, a carbon source, and an acid, the bimetallic nanoframe having a higher molar ratio of Pt to Group 8-11 metal than that of the bimetallic structure, the bimetallic nanoframe having the formula:

(Pt)ₐ(M²)_{b},
wherein: a is the amount of Pt; b is the amount of M²; and a molar ratio of a:b is from about 99:1 to about 25:75.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, element, or elements and vice versa, e.g., the terms “comprising,” “consisting essentially of,” “consisting of” also include the product of the combinations of elements listed after the term.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa, e.g., the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “a metal” include aspects comprising one, two, or more metals, unless specified to the contrary or the context clearly indicates only one metal is included.

While the foregoing is directed to aspects of the present disclosure, other and further aspects of the disclosure may be devised without departing from the basic scope thereof, and the scope thereof is determined by the claims that follow.

What is claimed is:

1. A process for forming a carbon-supported nanoframe, the process comprising:
forming a bimetallic structure by reacting a first precursor comprising platinum (Pt) and a second precursor comprising a Group 8-11 metal at a temperature of about 80° C. to about 300° C., wherein the Group 8-11 metal is free of Pt; and
forming a carbon-supported bimetallic nanoframe by reacting a mixture comprising the bimetallic structure, a carbon source, and an acid, wherein:
the carbon-supported bimetallic nanoframe comprises a bimetallic nanoframe chemically bonded to a carbon support; and
the bimetallic nanoframe has a higher molar ratio of Pt to Group 8-11 metal than a molar ratio of Pt to Group 8-11 metal of the bimetallic structure.

2. The process of claim 1, wherein a weight ratio of the bimetallic structure to the carbon source used to form the carbon-supported bimetallic nanoframe is from about 5:1 to about 1:10.

3. The process of claim 1, wherein:
the acid is an inorganic acid; and
the mixture comprising the bimetallic structure, the carbon source, and the acid are reacted at a temperature of about 10° C. to about 100° C.

4. The process of claim 1, wherein the acid comprises acetic acid, sulfuric acid, phosphoric acid, perchloric acid, or combinations thereof.

5. The process of claim 1, wherein the Group 8-11 metal comprises Fe, Ru, Os, Co, Rh, Ir, Ni, Pd, Cu, Ag, Au, or combinations thereof.

6. The process of claim 1, wherein the bimetallic nanoframe comprises:
an interior that is at least partially hollow; and
a plurality of facets encapsulating the interior, each facet of the plurality of facets comprising metal atoms.

7. The process of claim 6, wherein about 70% or more of the metal atoms are Pt.

8. The process of claim 6, wherein about 85% or more of the metal atoms are Pt.

9. The process of claim 1, wherein the bimetallic nanoframe, when supported on carbon, has a mass activity of greater than 0.23 A/mg (Pt) at 0.9 V with a reference to a reversible hydrogen electrode (V_{RHE}).

10. A process for forming a carbon-supported nanoframe, the process comprising:
introducing a first metal precursor comprising a Group 8-11 metal with a mixture comprising a phosphorous-containing compound and a second metal precursor comprising a Group 10-11 metal to form a bimetallic structure, the Group 8-11 metal and the Group 10-11 metal being different, the Group 8-11 metal and the Group 10-11 metal being free of platinum;
introducing a platinum-containing precursor with the bimetallic structure to form a trimetallic structure; and
forming a carbon-supported trimetallic nanoframe by reacting a mixture comprising the trimetallic structure, a carbon source, and an acid, wherein:
the carbon-supported trimetallic nanoframe comprises a trimetallic nanoframe chemically bonded to a carbon support; and
the trimetallic nanoframe has a higher molar ratio of Pt to total amount of Group 8-11 and Group 10-11 metal than a molar ratio of Pt to a total amount of Group 8-11 and Group 10-11 metal of the trimetallic structure.

11. The process of claim 10, wherein a weight ratio of the trimetallic structure to the carbon source used to form the carbon-supported trimetallic nanoframe is from about 5:1 to about 1:10.

12. The process of claim 10, wherein:
the acid is an inorganic acid; and
the mixture comprising the trimetallic structure, the carbon source, and the acid are reacted at a temperature of about 10° C. to about 100° C.

13. The process of claim 10, wherein the acid comprises acetic acid, sulfuric acid, phosphoric acid, perchloric acid, or combinations thereof.

14. The process of claim 10, wherein:
the Group 8-11 metal comprises Fe, Ru, Os, Co, Rh, Ir, Ni, Pd, Cu, Ag, Au, or combinations thereof; and
the Group 10-11 metal comprises Ni, Pd, Cu, Ag, Au, or combinations thereof.

15. The process of claim 10, wherein the trimetallic nanoframe comprises:
an interior that is at least partially hollow; and
a plurality of facets encapsulating the interior, each facet of the plurality of facets comprising metal atoms.

16. The process of claim 15, wherein about 70% or more of the metal atoms are Pt.

17. A process for converting a solid catalyst to a conversion product, the process comprising:
exposing a solid metal catalyst and a carbon source to an acid to form an at least partially hollow metal catalyst chemically bonded to a carbon support, wherein:
each of the solid metal catalyst and the at least partially hollow metal catalyst comprises Pt and at least one Group 8-11 metal of the periodic table of the elements;
the at least one Group 8-11 metal is free of Pt; and
a molar ratio of Pt to the at least one Group 8-11 metal of the at least partially hollow metal catalyst is higher than a molar ratio of Pt to the at least one Group 8-11 metal of the solid metal catalyst.

18. The process of claim 17, wherein a weight ratio of the solid metal catalyst to the carbon source used to form the at least partially hollow metal catalyst chemically bonded the carbon support is from about 5:1 to about 1:10.

19. The process of claim 17, wherein the carbon source comprises a material selected from the group consisting of carbon black, carbon nanotube, carbon nanofiber, mesoporous carbon, carbon nanowire, acetylene black, graphite, graphene, graphene oxide, fullerene, and combinations thereof.

20. The process of claim 17, wherein the at least one Group 8-11 metal is selected from the group consisting of Fe, Ru, Os, Co, Rh, Ir, Ni, Pd, Cu, Ag, Au, and combinations thereof.
